(19) United States
(12) Patent Application Publication
(10) Pub. No.: US 2018/0264386 A1
(43) Pub. Date: Sep. 20, 2018

(54) FILTER MEDIA COMPRISING CELLULOSE FILAMENTS

(71) Applicant: FPINNOVATIONS, Pointe-Claire (CA)

(72) Inventors: François DROLET, Longueuil (CA); Michelle Agnes RICARD, Pointe-des-Cascades (CA); Cloé BOUCHARD-AUBIN, Laval (CA); Natalie PAGÉ, Laval (CA); Gilles DORRIS, Vimont (CA)

(21) Appl. No.: 15/744,770

(22) PCT Filed: Jul. 18, 2016
(86) PCT No.: PCT/CA2016/050841

§ 371 Date: Jan. 13, 2018

Related U.S. Application Data
(60) Provisional application No. 62/193,141, filed on Jul. 16, 2015.

(51) Int. Cl. B01D 39/16; B01D 39/18; B01D 39/20

(52) U.S. Cl. CPC B01D 39/1623; B01D 39/18; B01D 2239/1233; B01D 2239/1291; B01D 2239/1275; B01D 39/2017

(57) ABSTRACT

The present disclosure relates to filter media comprising base filter fibers and cellulose filaments. For example, cellulose filaments can increase at least one mechanical property of the filter media as compared to filter media prepared from the base filter fibers alone. The disclosure also relates to various processes for preparing a filter medium, processes for increasing filtration efficiency of a filter medium, processes for increasing a minimum efficiency reporting value (MERV) rating of a filter medium.

### CROSS-REFERENCE TO RELATED APPLICATIONS

The present application claims the benefit of priority from co-pending U.S. provisional application No. 62/193,141 filed on Jul. 16, 2015, the contents of which are incorporated herein by reference in their entirety.

### FIELD OF THE DISCLOSURE

The present disclosure relates to filter media that comprise cellulose filaments (CF).

### BACKGROUND OF THE DISCLOSURE

Filters are used in a variety of applications to remove particles from either gases or liquids. A filter includes the filter medium, which is the part of the filter that performs the removal of particles from the gases or liquids. A filter may further include structural elements for physically supporting the filter medium, such as a frame.

A fibrous filter medium includes fibers or fibrous materials.

Fibers can be made of a variety of materials including cellulose, glass, carbon, ceramic, silica and synthetic polymers such as nylon, rayon, polyolefins, polyesters, polyaramids, polyimides, polyacrylics and polyamides. In addition to the fibers, a fibrous filter medium often includes additives such as binders or saturating agents. Binders are added to the filter medium to hold fibers together and to improve the structural integrity of the filter medium. Examples of binders include resins, low glass transition temperature latexes and fibers that can be thermally bonded. In some applications, a saturating agent can also be used to impregnate the filter medium. In others, a support or stiffening layer may be included in the design of the filter medium to improve the mechanical properties of the filter medium.

Filtration performance is typically described in terms of three key attributes: 1) the efficiency of filtration for the capture of contaminants of different sizes from the carrying gas or liquid, usually measured as percentage removal of a given contaminant from the carrying gas or liquid, 2) the resistance the filter offers to the moving gas or liquid, usually measured as pressure drop across the filter, and 3) the dust holding capacity, usually measured as the amount of contaminants the filter can hold at a given maximum pressure drop. Fiber diameter is an important factor in controlling the filtration performance of filter media. In general, filter media that include smaller diameter fibers have higher filtration efficiency but lower permeability than filter media that include larger diameter fibers. In addition, because of their small average pore size, filter media made from finer fibers tend to suffer from premature clogging resulting in a lower dust holding capacity.

To prevent premature clogging and accommodate different filter applications, a commercial filter medium often contains fibers of two or more diameters arranged in a sometimes complex composite structure (U.S. Pat. No. 3,201,926, U.S. Pat. No. 5,714,076). The fibers can be distributed uniformly or non-uniformly throughout the filter medium. A common approach is to provide a non-uniform distribution of the fibers by placing one or multiple layers of coarse fiber filter medium atop finer fibers. For example, larger diameter fibers are often placed upstream of the smaller diameter fibers. In this way, the larger diameter fibers capture the larger particles and prevent them from clogging the pores in the downstream fine fiber layer (U.S. Pat. No. 3,201,926, U.S. Pat. No. 5,672,188, U.S. Pat. No. 5,714,067, U.S. Pat. No. 5,785,725). The layers from coarse fibers may also provide strength and stiffness to the filter medium (U.S. Pat. No. 5,948,344, U.S. Pat. No. 7,993,427). Binders and saturating agents may also be added for the same purpose.

Fibrous filter media that include fibers with a diameter of a few microns or less are of interest to the filtration industry because of their ability to capture fine particles. Micron or submicron diameter fibers can be made through several processes.

A meltblown process allows the producing of microfibers having a diameter as low as 1 or 2 microns. While filter media that include fibers made from a meltblown process have satisfactory filtration efficiency, they are usually weak and structurally deficient.

Polymeric fibers with much smaller diameter can be produced by such processes as electrospinning a polymer solution. In that case, nanofibers with a diameter below 100 nanometers can be manufactured. For example, in US 2012/0204527A, U.S. Pat. No. 8,118,901, U.S. Pat. No. 7,318,852, U.S. Pat. No. 7,179,317, U.S. Pat. No. 6,924,028 and U.S. Pat. No. 6,743,273, Chung et al. disclose different polymer blends from which fine fibers with improved physical and chemical stability can be produced. The patent application also covers the layer of fibers less than one micron thick that can be made from these fine fibers by electrospinning. The fine layer can be adhered to a substrate providing strength, stiffness and pleatability and then used in multilayered filter products. U.S. Pat. No. 8,303,693 relates to filtration media comprising at least one fine fiber layer and one coarse fiber layer positioned upstream from the fine fiber layer. The finer fibers formed by electrospinning a polymer solution, have a preferred diameter between 100 and 300 nanometers and the layer they form has a thickness between 10 and 1000 microns. The fine layer may also include a plurality of substrate nanoparticles randomly placed among the fine fibers. The addition of particles to a web of fine fibers is also described in patent application US 2013/0008853. These particles can react, absorb or adsorb material dispersed or dissolved in a fluid.

Glass fibers of different diameters are also used in a variety of filtration applications. Larger fibers produced by processes such as continuous draw or rotary spinning, are used in applications requiring relatively low filtration efficiency and often in conjunction with synthetic fibers (U.S. Pat. No. 6,555,489, U.S. Pat. No. 7,582,132 and U.S. Pat. No. 7,608,125). For applications requiring higher efficiency, fine glass fibers produced by the flame attenuation process are commonly used. These fibers have a diameter ranging in size between 0.1 and 5.5 microns. Mats of these fibers are usually formed by a wetlaid or papermaking process, although an air-laid process can also be used (U.S. Pat. No. 5,785,725, EP0878226). Flame attenuated glass fibers are often used in applications requiring very high filtration efficiency, such as HEPA filters that capture at least 99.97% of all airborne particles with diameter of 0.3 microns. Glass fiber blankets used in HEPA filters are sometimes formed under very acidic conditions to produce some level of bonding between the fibers via acid attack. However, in many glass fiber media, a binder is added to the composition of the medium in order to hold the fibers together.

While all the fine fibers described above have well-defined diameters, it is also possible to add fibrillated fibers to the composition of filter media. Fibrillated fibers include a parent fiber that branches into smaller diameter fibrils which can themselves branch into more fibrils of even smaller diameter. Fibrillated fibers with fibrils of size below 1 micron and preferably below 500 nm are of interest because of their superior filtering ability. Such fibers can be made from materials such as synthetic cellulose (lyocell fibers) or acrylic polymers. While these fibers do not have the ability to form bonds, the fibrils tend to generate entanglement between the fibers thereby providing some strength to the filter medium. Examples of filter media made from mixtures of fine glass fibers, fibrillated lyocell fibers and binders are given in U.S. Pat. No. 6,872,311 and patent application US 2012/0152859.

Addition of very fine fibers with a diameter below one micron to a filter medium results in filters with superior filtering ability and several different processes currently exist to produce such fibers from a variety of materials. However, none of the existing technologies produces very fine fibers with a self-bonding ability such that they can produce filter media with superior strength even when added in small amounts to the filter composition.

It would thus be highly desirable to be provided with a device, system or method that would at least partially address the disadvantages of the existing technologies.

### SUMMARY OF THE DISCLOSURE

It was found that in a filter media that comprises a plurality of base fibers and various amounts of cellulose filaments (CF), the filaments can contribute substantially to both filtration efficiency and mechanical properties. For example, the characteristics of CF that include a thin width, a ribbon-like morphology, a high aspect ratio and a high hydrogen-bonding capacity can facilitate the formation of a plurality of structures within the filter media. CF can assume many different physical forms all of which contribute to changing the properties of the resulting filter media. The forms CF can assume within the medium include individual filaments, filaments entangled amongst themselves or with the base fibers, filaments that have wrapped around themselves or with the base fibers, partially coalesced filaments, web-like structures and film-like structures. These structures of various shapes and sizes can change the pore structure and tortuosity of the filter medium as well as its filtration performance and mechanical properties. The degree of hydrogen bonding or coalescence between filaments in the filter structure can be adjusted by different means. These means include changing the amount of filaments, the type or grade of filaments, adding chemical additives such as debonders to the filter composition and/or modifying the method used to produce the filter medium. Methods for producing filter media of the present disclosure are wetlaid or foam-forming processes followed by drying under ambient conditions, through air drying, through heat or in a freeze-dryer. In another aspect, the disclosure thus provides methods for producing filter media containing cellulose filaments that have pore structures tailored for specific filtration or other applications.

According to an aspect of the present disclosure, there is provided a filter medium comprising:

base filter fibers; and

cellulose filaments.

According to another aspect of the present disclosure, there is provided a filter medium comprising:

base filter fibers; and

cellulose filaments,

wherein the filter medium has a Gurley bending stiffness of at least about 30 mgf (milligrams force).

According to another aspect of the present disclosure, there is provided a filter medium comprising:

base filter fibers; and

cellulose filaments,

wherein the filter medium has a Gurley bending stiffness of at least about 100 mgf (milligrams force).

According to another aspect of the present disclosure, there is provided a filter medium comprising:

base filter fibers; and

cellulose filaments,

wherein the filter medium has a tensile strength of at least about 0.02 kN/m.

According to another aspect of the present disclosure, there is provided a filter medium comprising:

base filter fibers; and

cellulose filaments,

wherein the filter medium has a tensile strength of at least about 0.2 kN/m.

According to another aspect of the present disclosure, there is provided a filter medium comprising:

base filter fibers; and

cellulose filaments,

wherein the base filter fibers and the cellulose filaments form a filtering layer that is substantially free of binding material.

According to another aspect of the present disclosure, there is provided a filter medium comprising:

base filter fibers; and

cellulose filaments,

wherein the base filter fibers and the cellulose filaments form a filtering layer having a thickness of less than 10 mm.

According to another aspect of the present disclosure, there is provided a filter medium comprising:

base filter fibers; and

cellulose filaments,

wherein the base filter fibers and the cellulose filaments form a filtering layer having a thickness of about 0.005 mm to about 10 mm.

According to another aspect of the present disclosure, there is provided a filter medium comprising:

base filter fibers; and

cellulose filaments,

wherein the cellulose filaments are combined with the base filter fibers in proportions suitable for increasing at least one mechanical property of the base filter fibers as compared to the base filter fibers taken alone.

According to another aspect of the present disclosure, there is provided a filter medium comprising:

base filter fibers; and

cellulose filaments,

wherein the cellulose filaments are combined with the base filter fibers in proportions suitable for increasing filtration efficiency and at least one mechanical property of the base filter fibers as compared to the base filter fibers taken alone.

According to another aspect of the present disclosure, there is provided a filter medium comprising:

base filter fibers; and

cellulose filaments,

wherein the cellulose filaments are combined with the base filter fibers in proportions suitable for increasing filtration efficiency by at least 1% and tensile strength by at least 0.02 kN/m of the base filter fibers as compared to the base filter fibers taken alone.

According to another aspect of the present disclosure, there is provided a filter medium comprising:

base filter fibers; and

cellulose filaments,

wherein the cellulose filaments are combined with the base filter fibers in proportions suitable for increasing at least one mechanical property of the base filter fibers as compared to a filter medium that comprises the same base filter fibers but that excludes the presence of the cellulose filaments.

According to another aspect of the present disclosure, there is provided a filter medium comprising:

base filter fibers; and

cellulose filaments,

wherein the cellulose filaments are combined with the base filter fibers in proportions suitable for increasing filtration efficiency and at least one mechanical property of the base filter fibers as compared to a filter medium that comprises the same base filter fibers but that excludes the presence of the cellulose filaments.

According to another aspect of the present disclosure, there is provided a filter medium comprising:

base filter fibers; and

cellulose filaments,

wherein the cellulose filaments are combined with the base filter fibers in proportions suitable for increasing filtration efficiency by at least 1% and tensile strength by at least 0.02 kN/m of the base filter fibers as compared to a filter medium that comprises the same base filter fibers but that excludes the presence of the cellulose filaments.

According to another aspect of the present disclosure, there is provided a filter medium comprising:

base filter fibers; and

cellulose filaments;

wherein the filter medium has:
a grammage of about 30 to about 150 g/m²;
a MERV rating of at least 8;
a pressure drop below 200 Pa;
a tensile strength of at least 0.1 kN/m; and
a bending stiffness of at least 200 mgf.

According to another aspect of the present disclosure, there is provided a filter medium comprising:

base filter fibers; and

cellulose filaments;

wherein the filter medium has:
a grammage of about 40 to about 100 g/m²;
a filtration efficiency of at least 99%,
a pressure drop below 300 Pa;
a tensile strength of at least 0.1 kN/m; and
a bending stiffness of at least 200 mgf.

According to another aspect of the present disclosure, there is provided a filter medium comprising:

base filter fibers; and

cellulose filaments,

wherein the filter medium has a tensile index of at least about 0.2 N·m/g.

According to another aspect of the present disclosure, there is provided a filter medium comprising:

base filter fibers; and

cellulose filaments,

wherein the filter medium has a tensile index of at least about 2 N·m/g.

According to another aspect of the present disclosure, there is provided a process for preparing a filter medium, the process comprising:
preparing a suspension comprising base filter fibers and cellulose filaments at a concentration of about 0.05 g/L to about 1.0 g/L,
forming the filter medium by draining the suspension through a forming fabric or mesh; and
drying the filter medium, thereby causing at least one of hydrogen bonding of the cellulose filaments, coalescence of the cellulose filaments and entanglement between the cellulose filaments and/or between the cellulose filaments and the base filter fibers.

According to another aspect of the present disclosure, there is provided a process for preparing a filter medium, the process comprising:
preparing a suspension comprising base filter fibers and cellulose filaments at a concentration of about 0.05 g/L to about 1.0 g/L;
forming the filter medium by draining the suspension through a forming fabric or mesh;
drying the filter medium; and
controlling pore geometry and/or pore size of the filter medium by selecting at least one of the concentration of the cellulose filaments and grade of the cellulose filaments.

According to another aspect of the present disclosure, there is provided a process for preparing a filter medium, the process comprising:
preparing a suspension comprising base filter fibers and cellulose filaments at a concentration of about 0.05 g/L to about 1.0 g/L,
forming the filter medium by draining the suspension through a forming fabric or mesh; drying the filter medium; and
controlling degree of coalescence of the cellulose filaments by selecting at least one of the concentration of the cellulose filaments, grade of the cellulose filaments and/or by pre-treating the cellulose filaments mechanically or with chemicals and optionally heat, freeze-drying, solvent exchange or by chemical addition (such as debonding agents) to the suspension.

According to another aspect of the present disclosure, there is provided a process for preparing a filter medium, the process comprising:
combining base filter fibers and cellulose filaments in a dilute suspension;
forming the filter medium by draining the suspension through a forming fabric or mesh; and
drying the filter medium, thereby causing at least one of coalescence and entanglement between the cellulose filaments and/or between the cellulose filaments and the base filter fibers.

According to another aspect of the present disclosure, there is provided a process for preparing a filter medium, the process comprising:
combining base filter fibers and cellulose filaments in a dilute suspension;
forming the filter medium by draining the suspension through a forming fabric or mesh; and
drying the suspension, thereby causing at least one of hydrogen bonding, coalescence and entanglement between the cellulose filaments and/or between the cellulose filaments and the base filter fibers.

According to another aspect of the present disclosure, there is provided a process for preparing a filter medium, the process comprising:
preparing a suspension in water or in another solvent comprising base filter fibers and cellulose filaments at a concentration of about 0.05 g/L to about 1.0 g/L;
forming the filter medium by draining the suspension through a forming fabric or mesh; and
drying the filter medium by heat, freeze-drying, through-air-drying, or air drying, thereby causing at least one of hydrogen bonding of the cellulose filaments, coalescence of the cellulose filaments and entanglement between the cellulose filaments and/or between the cellulose filaments and the base filter fibers.

According to another aspect of the present disclosure, there is provided a process for preparing a filter medium, the process comprising:
preparing a suspension comprising base filter fibers and cellulose filaments at a concentration of about 0.05 g/L to about 1.0 g/L;
forming the filter medium by draining the suspension through a forming fabric or mesh;
drying by heat, freeze drying, through-air-drying, or air drying the filter medium comprising base filter fibers and cellulose filaments; and
controlling pore geometry and/or pore size of the filter medium by selecting at least one of the concentration of the cellulose filaments and grade of the cellulose filaments.

According to another aspect of the present disclosure, there is provided a process for preparing a filter medium, the process comprising:
preparing a suspension comprising base filter fibers and cellulose filaments at a concentration of about 0.05 g/L to about 1.0 g/L;
forming the filter medium by draining the suspension through a forming fabric or mesh;
drying by heat, freeze drying, through-air-drying, or air drying the filter medium comprising base filter fibers and cellulose filaments; and
controlling degree of hydrogen bonding and/or coalescence of the cellulose filaments by selecting at least one of the concentration of the cellulose filaments, grade of the cellulose filaments and/or by pre-treating the cellulose filaments mechanically or with chemicals and optionally heat, freeze drying, solvent exchange or by chemical addition of debonding agents to the suspension.

According to another aspect of the present disclosure, there is provided a process for preparing a filter medium, the process comprising:
preparing a suspension comprising base filter fibers and cellulose filaments at a concentration of about 0.05 g/L to about 1.0 g/L;
forming the filter medium by a foam-forming process; and
drying by heat, freeze drying, through-air-drying, or air drying the filter medium comprising base filter fibers and cellulose filaments.

According to another aspect of the present disclosure, there is provided a process for increasing filtration efficiency of a filter medium that comprises base filter fibers, the process comprising replacing at least a portion of the base filter fibers with cellulose filaments or adding at least a portion of cellulose filaments to the filter medium.

According to another aspect of the present disclosure, there is provided a process for increasing filtration efficiency of a filter medium that comprises base filter fibers and a binder, the process comprising replacing at least a portion of the binder with cellulose filaments or adding at least a portion of cellulose filaments to the filter medium.

According to another aspect of the present disclosure, there is provided a process for improving mechanical properties (for example, tensile strength and/or bending stiffness) of a filter medium that comprises base filter fibers, the process comprising replacing at least a portion of the base filter fibers with cellulose filaments or adding at least a portion of cellulose filaments to the filter medium.

According to another aspect of the present disclosure, there is provided a process for improving mechanical properties (for example, tensile strength and/or bending stiffness) of a filter medium that comprises base filter fibers and a binder, the process comprising replacing at least a portion of the binder with cellulose filaments or adding at least a portion of cellulose filaments to the filter medium.

According to another aspect of the present disclosure, there is provided a process for increasing a minimum efficiency reporting value (MERV) rating of a filter medium that comprises base filter fibers, the process comprising replacing at least a portion of the base filter fibers with cellulose filaments or adding at least a portion of cellulose filaments to the filter medium.

According to another aspect of the present disclosure, there is provided a process for increasing a minimum efficiency reporting value (MERV) rating of a filter medium that comprises base filter fibers and a binder, the process comprising replacing at least a portion of the binder with cellulose filaments or adding at least a portion of cellulose filaments to the filter medium

According to another aspect of the present disclosure, there is provided a process for improving mechanical properties of a filter medium that comprises base filter fibers, the process comprising replacing at least a portion of the base filter fibers with cellulose filaments or adding at least a portion of cellulose filaments to the filter medium, wherein the cellulose filaments allow for increasing a bending stiffness of the filter medium, a tensile strength of the filter medium, a minimum filtration efficiency of the filter medium, a MERV rating of the filter medium, a uniformity of the filter medium, a tortuosity of the filter medium or a combination thereof.

According to another aspect of the present disclosure, there is provided a process for improving mechanical properties of a filter medium that comprises base filter fibers and a binder, the process comprising replacing at least a portion of the binder with cellulose filaments or adding at least a portion of cellulose filaments to the filter medium, wherein the cellulose filaments allow for increasing a bending stiffness of the filter medium, a tensile strength of the filter medium, a minimum filtration efficiency of the filter medium, a MERV rating of the filter medium, a uniformity of the filter medium, a tortuosity of the filter medium or a combination thereof.

According to another aspect of the present disclosure, there is provided a process for increasing tortuosity of a filter medium that comprises base filter fibers, the process comprising replacing at least a portion of the base filter fibers with cellulose filaments or adding at least a portion of cellulose filaments to the filter medium.

According to another aspect of the present disclosure, there is provided a process for increasing tortuosity of a filter medium that comprises base filter fibers and a binder, the process comprising replacing at least a portion of the binder with cellulose filaments or adding at least a portion of cellulose filaments to the filter medium.

According to another aspect of the present disclosure, there is provided a process for improving grammage uniformity of a filter medium that comprises base filter fibers, the process comprising replacing at least a portion of the base filter fibers with cellulose filaments or adding at least a portion of cellulose filaments to the filter medium.

According to another aspect of the present disclosure, there is provided a process for improving grammage uniformity of a filter medium that comprises base filter fibers and a binder, the process comprising replacing at least a portion of the binder with cellulose filaments or adding at least a portion of cellulose filaments to the filter medium.

According to another aspect of the present disclosure, there is provided a filter medium comprising base filter fibers and cellulose filaments, wherein the cellulose filaments entangle amongst themselves and/or entangle with the base filter fibers.

According to another aspect of the present disclosure, there is provided a filter medium comprising base filter fibers and cellulose filaments, wherein the cellulose filaments wrap among themselves and/or wrap around the base fibers.

According to another aspect of the present disclosure, there is provided a filter medium comprising base filter fibers and cellulose filaments, wherein the cellulose filaments form partially coalesced structures.

According to another aspect of the present disclosure, there is provided a filter medium comprising base filter fibers and cellulose filaments, wherein the cellulose filaments form web-like or film-like structures entangled with the base filter fibers.

According to another aspect of the present disclosure, there is provided a filter medium comprising base filter fibers and cellulose filaments, wherein the cellulose filaments generally form web-like or film-like structures between the base filter fibers.

According to another aspect of the present disclosure, there is provided a filter medium comprising base filter fibers and cellulose filaments, wherein the cellulose filaments assume different physical forms which contribute to changing the properties of the filter medium, optionally wherein the physical forms are individual filaments, filaments entangled amongst themselves and/or with the base fibers, filaments that have wrapped around themselves and/or with the base fibers, partially coalesced filaments, web-like structures, film-like structures and combinations thereof.

### DRAWINGS

The following drawings represent non-limitative examples in which:

FIG. 1 shows a modified sheet machine and mixing aerator used to make filter media: (A) photograph of modified deckle showing effectiveness of mixing with aerator; (B) schematic diagram of aerator inserted in deckle; (C) schematic diagram showing view from A:A in FIG. 1B, and (D) schematic diagram showing view from B:B in FIG. 1B,

FIG. 2 shows scanning electron micrographs of cellulose filaments (CF): (A) showing the ribbon-like nature of the CF. Scale bar shows 2.0 μm; (B) showing the high aspect ratio of length over width of CF. Arrows point to different portions of a single cellulose filament. Scale bar shows 100 μm;

FIG. 3 shows scanning electron micrographs showing portions of filter media containing CF: (A) illustrates the different ways that filaments arrange themselves around and between individual glass fiber rods. Scale bar shows 10.0 μm. Arrows at left hand side of image point to partially coalesced filaments; arrow at top points to a film-like structure; top two arrows at right hand side of image point to filaments wrapped around glass fibers; and bottom three arrows at right hand side of image point to glass fibers; (B) shows a web-like structure formed from partially coalesced cellulose filaments as well as the dimensions of some of its pores. Scale bar shows 10.0 μm;

FIG. 4 shows scanning electron micrographs of filter media showing the changes in pore structure for different dosages of CF by weight: (A) 0% CF; (B) 2% CF; (C) 5% CF: and (D) 10% CF. Scale bar shows 100 μm for FIGS. 4A, 4B and 4C and 200 μm for FIG. 4D;

FIG. 5 shows optical micrographs of glass fiber filter media containing (A) 0% CF and (B) 4% CF. Areas of low grammage detected in the micrographs of FIGS. 5A and 5B are shown in (C) and (D), respectively. The total area shown is 3.5×2.6 mm in all cases. Scale bar in FIGS. 5A and 5B shows 1000 μm;

FIG. 6 shows scanned images of glass fiber filter media containing (A) 0% CF and (B) 4% CF. Areas of low grammage detected in the scanned images of FIGS. 6A and 6B are shown in (C) and (D). The total area shown is 145×145 mm in all cases. Scale bar in FIGS. 6A and 6B shows 30 mm;

FIG. 7 shows a graph of air filtration efficiency (%) as a function of airborne particle size (μm) measured for four filter media containing varying amounts of CF: 0%, 2%, 5% and 10%. Filtration efficiency curves were obtained for 200 g/m² filter media made from glass fibers of 5.5 μm mean diameter and containing the desired amount of CF. The filtration efficiency and pressure drop (ΔP) were measured at a flow velocity of 10.5 ft/min;

FIG. 8 illustrates a graph showing measured tensile strength for filter media with different dosages of CF: 0%, 2%, 5% and 10%. The tensile strength was obtained for 200 g/m² filter media made from glass fibers of 5.5 μm mean diameter and containing the desired amounts of CF;

FIG. 9 illustrates a graph showing measured bending stiffness for filter media with different dosages of CF: 0%, 2%, 5% and 10%. The Gurley stiffness was obtained for 200 g/m² filter media made from glass fibers of 5.5 μm mean diameter and containing the desired amount of CF;

FIG. 10 compares the filtration efficiency of filter media containing different amounts of CF to the filtration efficiency of filter media containing various binders. Filtration efficiency curves were measured for various glass fiber filter media of 100 g/m² prepared with different binders. The filter media were made from glass fibers of 5.5 μm mean diameter and either (A) CF, (B) polyethylene (PE) fibrillated fibers, (C) polyvinyl alcohol (PVOH) fibers, (D) Co-Polyester/Polyester BCC1 (Co-PET/PET) bicomponent fibers or (E) an acrylic resin (AR). The results obtained with CF are included in all graphs for comparison purposes;

FIG. 11 illustrates a graph showing the tensile strength of filter media containing different amounts of either CF or different binding materials. Tensile strength was measured for 100 g/m² filter media made of glass fibers of 5.5 μm mean diameter and varying amounts as indicated on the graph of either CF, thermally bonded PE fibers, PVOH fibers, thermally bonded Co-PET/PET bicomponent fibers or acrylic resin;

FIG. 12 illustrates a graph showing the bending stiffness of filter media containing varying amounts of either CF or different binding materials. Gurley stiffness was measured for 100 g/m² filter media made of glass fibers of 5.5 μm mean diameter and varying amounts as indicated on the graph of either CF, thermally bonded PE fibers, PVOH fibers, thermally bonded Co-PET/PET bicomponent fibers or acrylic resin;

FIG. 13 shows a graph of filtration efficiency (E₁) as a function of tensile strength (kN/m). The 100 g/m² filter media were made from glass fibers of 5.5 μm mean diameter and CF or PE fibers or PVOH fibers or Co-PET/PET bicomponent fibers or an acrylic resin as indicated on the graph;

FIG. 14 shows how the drying method can impact the filtration efficiency of a filter medium. Comparison of filtration efficiency curves is shown for heat-dried and freeze-dried 100 g/m² filter media. The filter media were made from a mixture of glass fibers of 5.5 μm mean diameter and 10% CF. The filtration efficiency and pressure drop (ΔP) were measured at a flow velocity of 10.5 ft/min;

FIG. 15 shows a scanning electron micrograph of a commercial wetlaid filter media, rated MERV 14. Scale bar shows 100 μm. Arrow at the left hand side of the image points to the binder and the two arrows at the right hand side of the image point to glass fibers;

FIG. 16 shows filtration efficiency curves of filter media of different grammage as indicated on the graph made from glass microfibers of 4.0 μm mean diameter, with and without CF. The filtration efficiency and pressure drop (ΔP) were measured at a flow velocity of 10.5 ft/min,

FIG. 17 shows filtration efficiency curves for 100 g/m² filter media made from glass microfibres of 4.0 μm mean diameter and containing varying amounts of different CF as indicated on the graph. The filtration efficiency and pressure drop (ΔP) were measured at a flow velocity of 10.5 ft/min; and

FIG. 18 shows filtration efficiency curves for 75 g/m² filter media made from blends of glass fibres with a partial substitution of glass microfibers of mean diameter: (A) 2.7 or (B) 5.5 μm with CF (CF6).

### DESCRIPTION OF VARIOUS EMBODIMENTS

The following examples are presented in a non-limiting manner.

Unless otherwise indicated, the definitions and embodiments described in this and other sections are intended to be applicable to all embodiments and aspects of the present disclosure herein described for which they are suitable as would be understood by a person skilled in the art.

As used in the present disclosure, the singular forms “a”, “an” and “the” include plural references unless the content clearly dictates otherwise.

In embodiments comprising an “additional” or “second” component, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The expression “substantially free of binding material” as used herein when referring to the filter medium of the present disclosure refers to a filter medium that comprises less than 0.5% of a binding material. For example, the medium can comprise less than 0.25% or less than 0.1% of a binding material.

The terms “cellulose filaments” or “CF” and the like as used herein refer to filaments obtained from cellulosic fibers and having a high aspect ratio, for example, an average aspect ratio of at least about 200, for example, an average aspect ratio of from about 200 to about 1000 or about 5000, an average width in the nanometer range, for example, an average width of from about 30 nm to about 500 nm and an average length in the micrometer range or above, for example, an average length above about 100 μm, for example an average length of from about 200 μm to about 2 mm. The CF having, for example, an average thickness of about 30 nm to about 50 nm or about 40 nm. Such cellulose filaments can be obtained, for example, from a process which uses mechanical means only, for example, the methods disclosed in US Patent Application Publication No. 2013/0017394 filed on Jan. 19, 2012. For example, such method produces cellulose filaments that can be free of chemical additives and free of derivatization using, for example, a conventional high consistency refiner operated at solid concentrations (or consistencies) of at least about 20 wt %. The CF manufacturing process peels fibres along their long axis, exposing new hydroxyl groups and increasing the surface area available for hydrogen bonding. These cellulose filaments are, for example, under proper mixing conditions, re-dispersible in water or aqueous slurries of minerals. For example, the cellulosic fibers from which the cellulose filaments are obtained can be but are not limited to kraft fibers such as Northern Bleached Softwood Kraft (NBSK), but other kinds of suitable fiber are also applicable, the selection of which can be made by a person skilled in the art.

Cellulose filaments (CF) are long and thin fibrils of cellulose extracted from wood which may be, for example a naturally abundant, recyclable, degradable and/or non-toxic biomaterial. The term cellulose filaments is used to illustrate the fact that the unique production process of CF minimizes fiber cutting and leads to high aspect ratios. Cellulose filaments are physically detached from each other, and are substantially free of the parent cellulosic fiber (Cellulose Nanofilaments and Method to Produce Same. CA 2,799,123 to Hua, X. et al.). Large scale manufacturing of cellulose filaments can be accomplished by refining wood or plant fibers without chemicals or enzymes at a high to very high level of specific energy using high consistency refiners. (High Aspect Ratio Cellulose Nanofilaments and Method for their Production. WO 2012/097446, 2012 to Hua, X., et al.). They have superior reinforcement ability, better or similar to cellulose microfibrils or nanofibrils such as microfibrillated cellulose (MFC) or nanofibrillated cellulose (NFC) prepared using other methods because of their longer length and higher aspect ratio. The material is produced at solids content exceeding 20% and up to 60% and can be transported in this form using impervious bags or alternatively as dry rolls, or shredded films made after their manufacturing on fast paper machines (U.S. application Ser. No. 13/105,120).

The expression “ribbon-like” as used herein in reference to cellulose filaments refers, for example to a morphology of the cellulose filaments which is that of a long, thin flexible band.

The expression “Quality Factor” or “Q” as used herein refers to:

$$\frac{- ln ( 1 - \frac{E}{100} )}{Δ P} ,$$

wherein E is the filtration efficiency measured at the most penetrating particle size (for example 0.35 μm) and expressed as a percentage, and ΔP is the pressure drop in Pa, measured across the filter medium at a specific flow velocity (for example 10.5 ft/min).

The expression “MERV” or “Minimum Efficiency Reporting Value” as used herein refers to a scale created by the ASHRAE society to measure the filtration efficiency of air filters.

The expression “HEPA” or “High Efficiency Particulate Air” as used herein in reference to filters, refers, for example, to filters that are designed to trap a vast majority of very small particulate contaminants from an air stream. Specifically, their filtration efficiency measured at an airborne particle size of 0.3 μm must be at least 99.97%.

The expression “entanglement between the cellulose filaments and/or between the cellulose filaments and the base filter fibers” as used herein refers, for example, to the twisting together or enmeshing of the filaments themselves and/or twisting together or enmeshing of the filaments and the base filter fibers.

The expression “wrapping around the base filter fibers” as used herein in reference to cellulose filaments refers, for example, to the way that the long, thin, ribbon-like, and flexible cellulose filaments with their high aspect ratio coil or twist around the larger base fibers.

The expression “partial coalescence of the cellulose filaments” as used herein refers, for example, to the formation of hydrogen bonds between two or more filaments over a portion of their length such that the filaments appear to partially fuse together into a different larger structure. This structure has zones of fusion alternating with zones that contain either single filaments or empty pores.

The expression “web-like structure” as used herein in reference to cellulose filaments refers, for example, to the interconnected network that is formed by a combination of individual filament segments, partially coalesced filaments and the open pores in between.

The expression “film-like structure” as used herein in reference to cellulose filaments refers, for example, to a thin, less-open and almost closed, skin-like structure formed when a plurality of cellulose filaments form hydrogen bonds with each other over a large and continuous area.

The expression “a portion of the cellulose filaments form hydrogen bonds amongst themselves” as used herein refers, for example, to the bonding or fusion of a portion of one filament to a portion of a second filament which in turn can bond to other filaments via hydrogen bonds.

The term “hydrogen bond” as used herein refers, for example to the bond formed between an electropositive atom, typically hydrogen and a strongly electronegative atom, such as oxygen. These bonds, even though much weaker than covalent or ionic bonds, are the main mechanisms responsible for making cellulosic fibers adhere to each other in paper. Hydrogen bonding occurs upon drying of the sheet during the papermaking process. Increasing the available surface and thus the exposure of hydroxyl groups present in cellulosic fibers promotes hydrogen bonding.

The present disclosure relates to the use of cellulose filaments in a filter medium for filters.

The CF used in filter media disclosed herein can be derived from wood or other natural fibers.

According to various exemplary embodiments, the filaments can be produced from wood chips, chemical, chemi-mechanical, or thermo-mechanical wood pulp fibers. The filaments can be described as individual fine threads unraveled or peeled from natural fibers. They are essentially free from the parent fiber in that they are generally not associated or attached to a fiber bundle, meaning that they are not fibrillated.

For example, the base filter fibers and the cellulose filaments can form a filtering layer having a thickness of about 0.005 mm to about 10 mm.

For example, the filter medium can have a bending stiffness of at least about 30 mgf, at least about 50 mgf, at least about 80 mgf, at least about 100 mgf, at least about 200 mgf, at least about 300 mgf, at least about 400 mgf, at least about 500 mgf, at least about 600 mgf, at least about 700 mgf, at least about 800 mgf, at least about 900 mgf, at least about 1000 mgf, at least about 2000 mgf, at least about 3000 mgf, at least about 4000 mgf, at least about 5000 mgf, at least about 6000 mgf, or at least about 7000 mgf.

For example, the filter medium can have a bending stiffness of about 100 to about 10000 mgf, about 500 to about 10000 mgf, about 1000 to about 10000 mgf, about 2000 to about 8000 mgf or about 2000 to about 7500 mgf.

For example, the filter medium can comprise at least about 0.25%, at least about 0.5%, at least about 1%, at least about 2%, at least about 3%, at least about 4%, at least about 5%, at least about 6%, at least about 7%, at least about 8%, at least about 9% or at least about 10% of cellulose filaments by weight, based on the total weight of the cellulose filaments and the base filter fibers.

For example, the filter medium can comprise about 0.1% to about 30%, about 0.5% to about 30%, about 1% to about 30%, about 0.1% to about 20%, about 0.5% to about 20%, about 1% to about 20%, about 0.5% to about 15%, about 0.5% to about 15%, about 1% to about 15%, about 2% to about 10%, or about 2% to about 5% of cellulose filaments by weight, based on the total weight of the cellulose filaments and the base filter fibers.

For example, the cellulose filaments can have an average length of about 100 μm to about 2 mm, an average diameter of about 30 nm to about 500 nm and/or an average aspect ratio of about 200 to about 1000 or about 5000.

For example, the filter medium can have a tensile strength of at least about 0.02 kN/m, at least about 0.05 kN/m, at least about 0.07 kN/m, at least about 0.1 kN/m, at least about 0.15 kN/m, at least about 0.2 kN/m, at least about 0.4 kN/m, at least about 0.5 kN/m, at least about 0.6 kN/m, at least about 0.8 kN/m, at least about 1.0 kN/m, at least about 1.2 kN/m, at least about 1.4 kN/m, at least about 2.0 kN/m, at least about 3.0 kN/m or at least about 5.0 kN/m.

For example, the filter medium can have a tensile strength of about 0.2 kN/m to about 2.0 kN/m, about 0.2 kN/m to about 1.6 kN/m, about 0.2 kN/m to about 1.5 kN/m, about 0.2 kN/m to about 1.4 kN/m or about 0.2 kN/m to about 1.3 kN/m.

For example, the filter medium can comprise about 2% to about 10% of cellulose filaments by weight and the filter medium can have a tensile strength of about 0.2 kN/m to about 4.0 kN/m. For example, the filter medium can comprise about 2% to about 10% of cellulose filaments by weight and the filter medium can have a tensile strength of about 0.2 kN/m to about 2.0 kN/m. For example, the filter medium can comprise about 2% to about 5% of cellulose filaments by weight and the filter medium can have a tensile strength of about 0.2 kN/m to about 0.8 kN/m. For example, the filter medium can comprise about 5% to about 10% of cellulose filaments by weight and the filter medium can have a tensile strength of about 0.7 kN/m to about 1.4 kN/m. For example, the filter medium can comprise at least about 2% of cellulose filaments by weight and the filter medium can have a tensile strength of about 0.2 kN/m. For example, the filter medium can comprise at least about 1% of cellulose filaments by weight and the filter medium can have a tensile strength of about 0.2 kN/m.

For example, the filter medium can have a tensile index of at least about 0.2 N·m/g, at least about 0.5 N·m/g, at least about 0.7 N·m/g, at least about 1 N·m/g, at least about 1.5 N·m/g, at least about 2 N·m/g, at least about 4 N·m/g, at least about 5 N·m/g, at least about 6 N·m/g, at least about 8 N·m/g, at least about 10 N·m/g, at least about 12 N·m/g, at least about 14 N·m/g, at least about 50 N·m/g, at least about 70 N·m/g, or at least about 100 N·m/g.

For example, the filter medium can have a tensile index of about 2 N·m/g to about 20 N·m/g, about 2 N·m/g to about 16 N·m/g, about 2 N·m/g to about 15 N·m/g, about 2 N·m/g to about 14 N·m/g or about 2 N·m/g to about 13 N·m/g.

For example, the filter medium can comprise about 2% to about 10% of cellulose filaments by weight and the filter medium can have a tensile index of about 2 N·m/g to about 20 N·m/g. For example, the filter medium can comprise about 2% to about 5% of cellulose filaments by weight and the filter medium can have a tensile index of about 2 N·m/g to about 8 N·m/g. For example, the filter medium can comprise about 5% to about 10% of cellulose filaments by weight and the filter medium can have a tensile index of about 7 N·m/g to about 14 N·m/g. For example, the filter medium can comprise at least about 2% of cellulose filaments by weight and the filter medium can have a tensile index of about 2 N·m/g. For example, the filter medium can comprise at least about 1% of cellulose filaments by weight and the filter medium can have a tensile index of about 2 N·m/g.

For example, the filter medium can be substantially free of binding material.

For example, the filter medium can have a pressure difference (ΔP) measured at a flow velocity of 10.5 feet/min between a first surface of the filter medium and a second surface of the filter medium of about 1 Pa to about 700 Pa, about 1 Pa to about 400 Pa, about 10 Pa to about 400 Pa, about 10 Pa to about 300 Pa, about 1 Pa to about 200 Pa or about 20 Pa to about 200 Pa. For example, the filter medium can have a pressure difference (ΔP) measured at a flow velocity of 10.5 feet/min between a first surface of the filter medium and a second surface of the filter medium of less than about 300 Pa or less than about 200 Pa.

For example, the filter medium can have a filtration efficiency of at least about 1% for airborne particles having a size of 0.3 μm, at least about 10% for airborne particles having a size of 0.3 μm, at least about 20% for airborne particles having a size of 0.3 μm, at least about 30% for airborne particles having a size of 0.3 μm, at least about 40% for airborne particles having a size of 0.3 μm, at least about 50% for airborne particles having a size of 0.3 μm, at least about 60% for airborne particles having a size of 0.3 μm, at least about 70% for airborne particles having a size of 0.3 μm, at least about 80% for airborne particles having a size of 0.3 μm, at least about 90% for airborne particles having an a size of 0.3 μm, at least about 95% for airborne particles having a size of 0.3 μm, at least about 97% for airborne particles having a size of 0.3 μm, at least about 99% for airborne particles having a size of 0.3 μm or at least about 99.97% for airborne particles having a size of 0.3 μm. For example, the filter medium can have a filtration efficiency of about 50% to about 90% for airborne particles having a size of 0.3 μm. For example, the filter medium can have a filtration efficiency of about 50% to about 80% for airborne particles having a size of 0.3 μm. For example, the filter medium can have a filtration efficiency of about 60% to about 90% for airborne particles having a size of 0.3 μm.

For example, a first portion of the base filter fibers and the first portion of the cellulose filaments can form a first layer having a thickness of at least 0.005 mm and a second portion of the base filter fibers and the second portion of the cellulose filaments can form a second layer having a thickness of at least 0.005 mm. For example, a first portion of the base filter fibers and the first portion of the cellulose filaments can form a first layer having a thickness of less than 10 mm and a second portion of the base filter fibers and the second portion of the cellulose filaments can form a second layer having a thickness of less than 10 mm. For example, a first portion of the base filter fibers and the first portion of the cellulose filaments can form a first layer having a thickness of about 0.005 mm to about 10 mm and a second portion of the base filter fibers and the second portion of the cellulose filaments can form a second layer having a thickness of about 0.005 mm to about 10 mm.

For example, the base filter fibers can be chosen from wood fibers, agricultural fibers, natural fibers, artificial fibers, and polymer fibers. For example the base filter fibers can be chosen from glass fibers, cellulose fibers, carbon fibers, ceramic fibers, silica fibers, nylon fibers, rayon fibers, polyolefin fibers, polyester fibers, polyamide fibers, polyaramid fibers, polyimide fibers, and polylactic acid fibers.

For example, the base filter fibers can be glass fibers or wood pulp fibers. For example, the base filter fibers can be chosen from curly pulp fibers.

For example, the base filter fibers can be glass fibers.

For example, the base filter fibers can be monodisperse glass fibers. For example, the base filter fibers can be monodisperse glass fibers having a mean diameter of about 0.5 to about 11 μm. For example, the the base filter fibers can be monodisperse glass fibers having a mean diameter of about 4 to about 8 μm. For example, the base filter fibers can be monodisperse glass fibers having a mean diameter of about 4 to about 6 μm.

For example, the base filter fibers can be wood pulp fibers.

For example, the filter medium can have a grammage of about 30 to about 150 g/m². For example, the filter medium can have a grammage of about 50 to about 120 g/m². For example, the filter medium can have a grammage of about 60 to about 100 g/m². For example, the filter medium can have a grammage of about 40 to about 100 g/m². For example, the filter medium can have a grammage of about 50 to about 100 g/m². For example, the filter medium can have a grammage of about 45 to about 90 g/m². For example, the filter medium can have a grammage of about 50 to about 75 g/m².

For example, a portion of the cellulose filaments can be entangled with the base filter fibers. For example, being entangled with the base filter fibers can comprise wrapping around the base filter fibers.

For example, the filter medium can have a quality factor of about 0.01 to about 0.05. For example, the filter medium can have a quality factor of about 0.005 to about 0.1.

For example, the filter medium can have a quality factor of about 0.005 to about 0.05, of about 0.01 to about 0.1 or of about 0.05 to about 0.1.

For example, the filter medium can have a MERV rating of at least 8, at least 10, at least 12 or at least 14. For example, the filter medium can have a MERV rating of about 8 to about 14.

For example, the filter medium can be a HEPA filter medium.

For example, the cellulose filaments can form web-like or film-like structures entangled with the base filter fibers.

For example, the cellulose filaments can form web-like or film-like structures between the base filter fibers.

For example, a portion of the cellulose filaments can be entangled with the base filter fibers. For example, being entangled with the base filter fibers can comprise wrapping around the base filter fibers.

For example, a portion of the cellulose filaments can coalesce locally, thereby forming a web-like or film-like structure.

For example, a portion of the cellulose filaments can form hydrogen bonds amongst themselves.

For example, the filter medium can have a stiffness sufficient for scoring and pleating of the filter medium.

For example, the filter medium can be formed from wet-laying the base filter fibers and the cellulose filaments.

For example, the wet-laying can comprise suspending the base filter fibers and the cellulose filaments in a dilute suspension and, after suspending, forming the filter medium by draining the suspension through a forming fabric or mesh and drying the cellulose filaments.

For example, the wet-laying can comprise suspending the base filter fibers and the cellulose filaments in a dilute suspension and, after suspending, forming and drying the filter medium comprising the base filter fibers and the cellulose filaments.

For example, the process can comprise drying by heat, freeze drying, through-air-drying, or air drying the filter medium comprising base filter fibers and cellulose filaments.

For example, the wet-laying can comprise:
preparing a suspension in water or in another solvent comprising base filter fibers and cellulose filaments at a concentration of about 0.05 g/L to about 1.0 g/L;
forming the filter medium by draining the suspension through a forming fabric or mesh or by a foam-forming process; and
drying by heat, freeze drying, through-air-drying, or air drying the filter medium comprising base filter fibers and cellulose filaments.

For example, the cellulose filaments can have an anionic charge or a cationic charge.

For example, the cellulose filaments can be hydrophobic or hydrophilic.

For example, in the filter media of the present disclosure:
a first portion of the base filter fibers and a first portion of the cellulose filaments can form a first layer, the first portion comprising a first percentage of cellulose filaments by weight based on the total weight of the first portion of cellulose filaments and the first portion of base filter fibers;
a second portion of the base filter fibers and a second portion of the cellulose filaments can form a second layer, the second portion comprising a second percentage of cellulose filaments by weight based on the total weight of the second portion of cellulose filaments and the second portion of base filter fibers; and
the first percentage and the second percentage can be different.

For example, in the filter media of the present disclosure:
a first portion of the base filter fibers and a first portion of the cellulose filaments can form a first layer, the first portion of cellulose filaments having a first grade/size;
a second portion of the base filter fibers and a second portion of the cellulose filaments can form a second layer, the second portion of cellulose filaments having a second grade/size; and
the first grade/size and the second grade/size can be different.

For example, the cellulose filaments can be non-fibrillated.

For example, a dosage of the cellulose filaments can be chosen based on a pore size of the filter medium.

For example, at least one dimension of the cellulose filaments can be chosen based on a pore size of the filter medium.

For example, a dosage of the cellulose filaments can be chosen based on a degree of hydrogen bonding of the cellulose filaments in the filter medium or coalescence of the cellulose filaments in the filter medium.

For example, the filtration efficiency at 0.3 μm particle size can be increased by about 1% to about 500%. For the sake of clarity, it is meant in the present disclosure that an increase of filtration efficiency such as found in Table 6, in which the difference between 0% CF that provides 41% of capture efficiency and 5% CF that provides 60% of capture efficiency, would be considered as a filtration efficiency that is increased by 46.3% (and not by 19%).

For example, tensile strength can be improved by about 0.02 kN/m to about 5 kN/m.

For example, tensile index can be improved by about 0.2 N·m/g to about 50 N·m/g.

For example, the mechanical properties can be chosen from bending stiffness, a tensile strength, burst index, stretch, brittleness and combinations thereof.

For example, the MERV rating can be increased by a value of at least 1.

For example, the tortuosity factor can be increased by a value of at least 1.

For example, the base filter fibers and the cellulose filaments can form a filtering layer that is substantially free of binding material.

For example, the process can comprise preparing a suspension comprising base filter fibers and cellulose filaments at a concentration of about 0.05 g/L to about 1.0 g/L.

For example, grade of cellulose filament can be determined by the processing conditions of cellulose filament production and the starting fibre material.

For example, preparing a suspension comprising the base filter fibers and cellulose filaments at a concentration of about 0.05 g/L to about 1.0 g/L can be carried out in water or in another solvent (for example an organic solvent).

For example, preparing a suspension comprising the base filter fibers and cellulose filaments at a concentration of about 0.05 g/L to about 1.0 g/L can comprise preparing a suspension comprising a liquid, the base filter fibers and cellulose filaments at a concentration of about 0.05 g/L to about 1.0 g/L. For example, the liquid can be a solvent or water.

The following non-limiting examples are illustrative of the present application:

### EXAMPLES

### Materials and Methods

The protocol for preparing the filter media comprised several steps including: CF samples made from different furnish and at different total specific energies, glass microfiber (GMF) sample, curly pulp fiber sample (CPF), polyethylene fibers (PEF), polyvinyl alcohol fibers (PVOHF), Co-Polyester/Polyester BCC1 bicomponent fibers (Co-PET/PET BF), addition of acrylic resin, consistency measurement, preparation of individual suspensions of dispersed CF, GMF, and CPF, preparation of a dispersed suspension of CF or PEF or PVOHF or Co-PET/PET BF and GMF or CPF, preparation of filter media using a sheet machine and wetlaid process, pressing and drying of filter media, spraying of an acrilyc resin on the dry filter media, and activation of PEF, Co-PET/PET BF or curing of the acrylic resin at high temperature. Subsequent to handsheet or filter making, filter analysis methods are described.

CF Samples:

CF samples were produced from northern bleached softwood kraft pulp (NBSK), thermomechanical pulp (TMP) or dissolving softwood pulp (DP) according to method described in WO2012/0974. CF of different grades were produced by passing pulp through a pilot refiner under different process conditions that would provide CF samples of different dimensions of length, width, thickness and surface area as well as different binding properties. Typically, filaments having received more energy have greater binding or strength as measured on handsheets of 20 g/m² of pure CF according to PAPTAC Standard Method C.4. Table 1 shows the fibre sources of the different CF used in the examples and the tensile index of 20 g/m² handsheets made from these different CF. Unless indicated otherwise in the text or figure, CF4 was used in all examples. Final CF consistency after refining was 30%.

TABLE 1
Tensile index of 20 g/m² handsheet made
from different grades of 100% CF.

| | | Tensile Index of 20 g/m² |
|---|---|---|
| CF Fiber Source | CF ID | handsheet of 100% CF (N · m/g) |
| NBSK | CF1 | 30 |
| | CF2 | 66 |
| | CF3 | 88 |
| | CF4 | 115 |
| | CF5 | 75 |
| | CF6 | 77 |
| Dissolving Pulp | CF7 | 57 |
| TMP Spruce Wood Chips | CF8 | 65 |

GMF Sample:

GMFs, Micro-Strand™ glass microfibers are shown in Table 2.

TABLE 2
Micro-Strand ™ glass microfiber identifications.

| Micro-Strand ™ | Mean Fiber Diameter (μm) |
|---|---|
| 104-475 | 0.50 |
| 106-475 | 0.65 |
| 108A | 1.0 |
| 110X-481 | 2.7 |
| 112X-475 | 4.0 |
| CX-475 | 5.5 |

Also, in some cases, Chop-Pak® H117 prechopped fiber glass strands with a mean diameter of 10.8 microns and lengths of ½ inch were used. All glass fibers used were from Johns Manville, Denver, Colo.

CPF Sample:

Curly pulp fibers were produced from northern bleached softwood kraft pulp using mechanical treatment.

PEF Sample:

Fybrel® EST8 is a polyethylene synthetic pulp (MiniFibers, Inc.) that is highly fibrillated. The average fiber length and diameter are 0.65-1.10 mm and 5 microns, respectively. The melting point of the fibers is 135° C.

PVOHF Sample:

Kuralon PVA fibers VPB 105-2 (Engineered Fibers Technology, LLC) are made from polyvinyl alcohol. The average fiber length and diameter are 4 mm and 11 microns, respectively. The dissolving temperature of the fibers in water is 60° C.

Co-PET/PET BF Sample:

Co-Polyester/Polyester BCC1 bicomponent fibers (MiniFibers, Inc.) are made up of a concentric composition of Co-Polyester sheath and a Polyester core. The melting point of the sheath is around 110° C. and of the core is around 250° C. The average fiber length and filament sizes are ⅛ inch and 2 denier per filament (dpf).

Acrylic Resin Sample:

Acrodur® 950L (BASF) is a water-based acrylic resin without latex. The resin starts crosslinking at temperatures higher than 150° C.

CF Dispersion:

CF was dispersed using a British disintegrator according to a modified PAPTAC Standard Method C10, where 24 g of oven-dried CF were placed in 2 L of deionized water at 80° C. for 15 min or 45,000 revolutions. Dispersion of CF was verified when no agglomerates or bundles were seen in a dilute 0.3% suspension of CF when placed in a glass vessel or in a 100% CF film of 20 g/m². Tensile properties of the CF film have been shown to be at their best when CF is fully dispersed.

GMF Dispersion:

Small pieces of hand-shredded GMFs were dispersed using a British disintegrator according to a modified PAPTAC Standard Method C10, where 24 g of oven-dried microfibers were placed in 2 L of deionized water at 20° C. for 30 min or 90,000 revolutions. It was normal to observe small agglomerations of GMF after the dispersion.

CPF Dispersion:

CPFs were dispersed using a British disintegrator according to a modified PAPTAC Standard Method 010 where the fibers (max 24 g oven-dried) were placed in 2 L of deionized water at 20° C. for 10 min or 30,000 revolutions.

PEF Dispersion:

PEFs were initially placed in 100° C. deionized water to liberate individual fibers.

CF (or PEF or PVOHF or Co-PET/PET BF) and GMF (or CPF) Dispersion:

Predetermined volumes of dispersed CF (or PEF or PVOHF or Co-PET/PET BF) and GMF (or CPF) were mixed using a British disintegrator according to a modified PAPTAC Standard Method 010 for 5 min or 15,000 revolutions.

Filter Preparation by a Wetlaid Process:

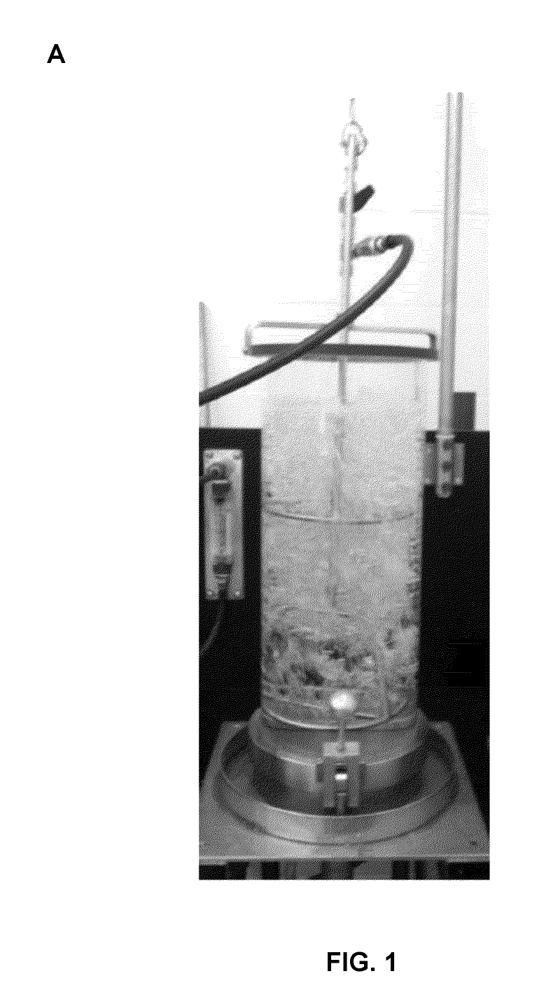

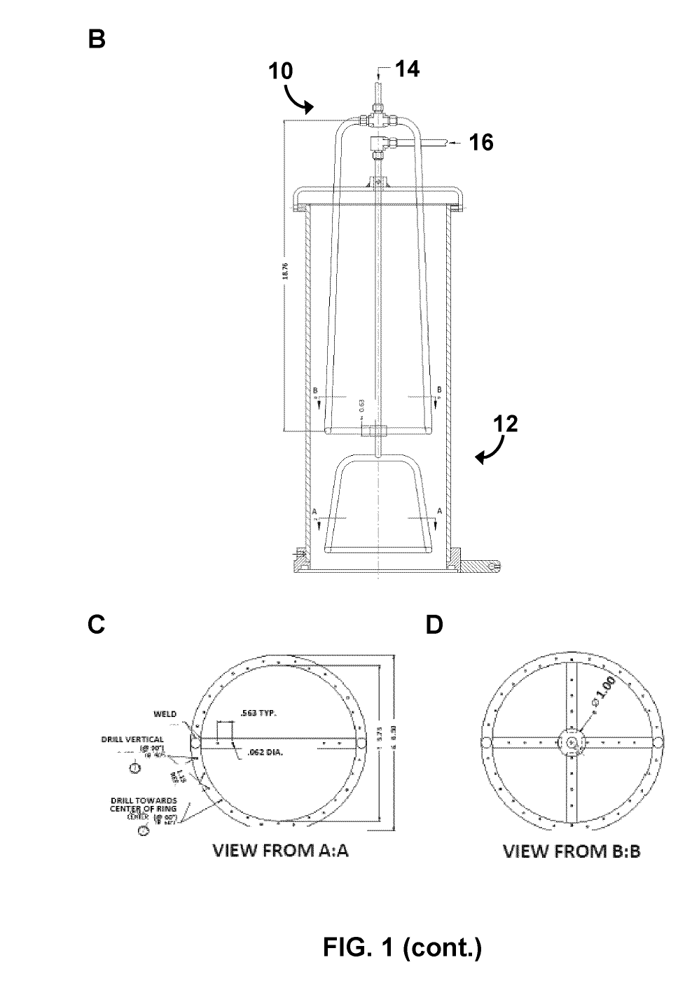

Filter media (with grammages varying from about 30 to about 200 g/m²) were made from CF (or PEF or PVOHF or Co-PET/PET BF) and GMF (or CPF) according to a modified PAPTAC standard method C.4. FIG. 1 shows, when compared to the PAPTAC method, modifications made to the handsheet machine that include a larger diameter deckle (8.8″ that could hold 18 L of water), a larger diameter screen (8.9″ external diameter and 8.5″ internal diameter), and introduction of an aerator for mixing the fiber suspensions in the deckle. For example, FIG. 1B shows a schematic diagram of the aerator 10 inserted in the deckle 12. Air inlets 14 and 16 are also labelled in the diagram.

The CF and GMF (or CPF) mixture was poured into a half-filled deckle containing deionized water, the water volume was then brought up to 16 L after which the suspension was mixed for 15 seconds via air injection at a flow rate of 2 standard cubic feet per minute. After mixing, the suspension was drained through a no. 70 or 150 stainless steel mesh to form a wetlaid filter or handsheet. To remove the wet handsheet from the steel mesh, the wet handsheet was gently couched three times using the couch roller described in the standard method. The handsheet can be air dried, dried by applying heat, through-air-dried or by a freeze-drying process. If the handsheet is dried by applying heat, it is placed between two blotting papers and passed through the Arkay Dual Dry (model 150) dryer with temperature set to 85° C. for a total of 2 to 4 passes of 3 minutes each depending of the grammage and type of base fibers used. The blotting papers are changed after each passage in the dryer. If the filter is dried by freeze-drying, the wet handsheet is soaked in liquid nitrogen for 30 seconds and then placed in a freeze-dryer (VirTis, Freezemobile 12SL) for at least one day.

PEF Activation:

To melt or activate the PEF in the filter media, the PEF-containing handsheet was placed between two Whatman no. 1 filter papers and then deposited over a plate heated at 150° C. After 5 minutes, the handsheet was turned over and heated for an additional 5 minutes.

Co-PET/PET BF Activation:

To melt or activate the Co-PET/PET bicomponent fiber in the filter media, the Co-PET/PET-containing handsheet was placed between parchment papers, then put between two blotter papers and then deposited over a plate heated at 150° C. The handsheet was heated for 2.5 minutes, and was turned over for another 2.5 minutes.

Acrylic Resin Application and Activation Process:

The acrylic resin was applied as a dilute solution sprayed onto dry filter media made from 100% glass microfibers. The concentration of the resin solution was adjusted according to the targeted dosage: a solution at a 1% concentration was used to obtain a dosage of 10% resin by weight in the final filter medium and a solution at 2% concentration was used to obtain a dosage of 20% resin by weight. A gun (Gravity Feed Porter Cable Spray Gun HVLP) was used to gently spray the resin solution onto the dry filter media until they were completely soaked with the resin solution. The filter media were then placed on an anti-adhesive film and dried in an oven at 160° C. for an hour.

Analysis of Filter Media Uniformity:

Optical black and white micrographs of laboratory filter media made from glass fibers with and without CF addition were taken with a Zeiss Axio Imager Z.1 microscope in transmitted light brighffield mode using a 2.5× objective. The filter media were also scanned at a resolution of 600 dpi in an 8-bit gray scale format using an ESPON Perfection V800 Photo scanner. A thresholding procedure available in Image Pro 6.2 software was used to detect regions of low grammage in both sets of images.

Other Filter Analysis Methods:

Analysis on laboratory made filter media or handsheets were performed according to standard methods established for paper or filtration products or for measuring porosity. The different test methods used are listed in Table 3.

TABLE 3
Test methods used.

| Method | Reference |
|---|---|
| Forming handsheets for | PAPTAC Standard C.4 |
| physical tests of pulp | |
| Pulp disintegration | PAPTAC Standard C.10 |
| Grammage of paper and | PAPTAC Standard D.3 |
| paperboard | |
| Thickness and apparent | PAPTAC Standard D.4 |
| density of paper and | |
| paperboard | |
| Consistency of stocks | PAPTAC Standard D.16 |
| Stiffness of paper and | PAPTAC Useful Method D.16U |
| paperboard (Gurley Method) | |
| Tensile breaking properties | PAPTAC Standard D.34 |
| of paper and paperboard | |
| (Constant rate of | |
| elongation method) | |
| Moisture determination for | PAPTAC Standard G.3 |
| chemical and physical | |
| analysis | |
| Mercury intrusion | Measured using AutoPore IV |
| porosimetry | Mercury Porosimeter, from |
| | Micromeritics |
| Pressure Drop | Frazier Permeability Tester |
| Filtration efficiency curves | Based on ASHRAE 52.2 Standard |
| | Measured at a flow velocity of |
| | 10.5 ft/min KCl aerosol, TSI |
| | 3330 particle counter |
| Mean flow and maximum pore | Measured using Porometer 3G, from |
| size | Quantachrome Instruments and Porofil |
| | as the wetting fluid |

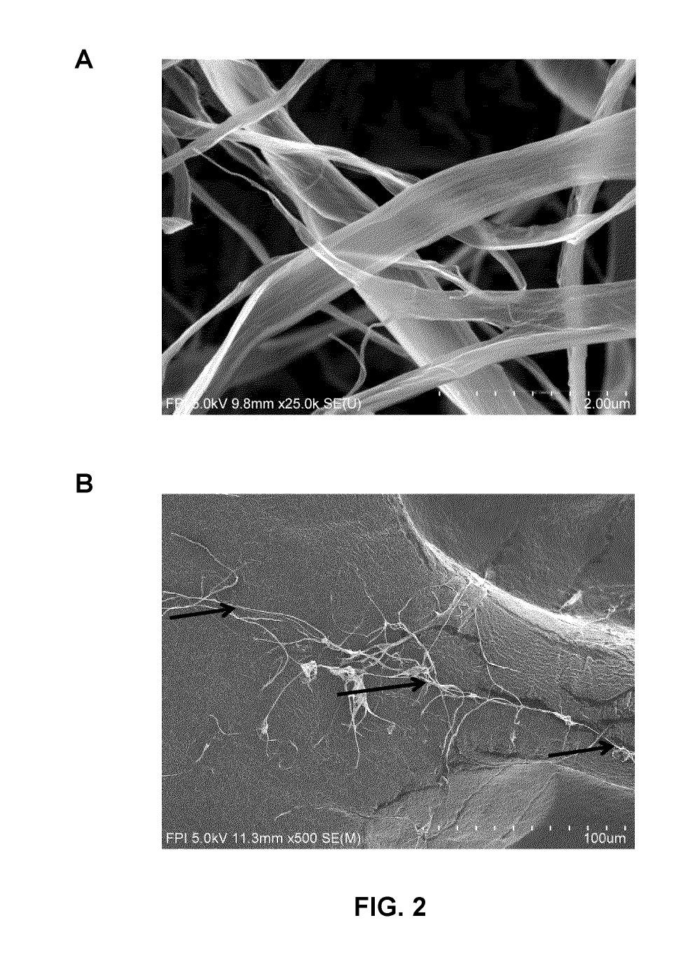

FIG. 2A is an electron micrograph showing the ribbon-like nature of the CF and their tendency to wrap around or entangle with themselves. In a filter medium, the various CF described herein can be combined with a plurality of base filter fibers. The base filter fibers may be fibers typically used in filter products, such as plant or wood fibers, glass fibers, regenerated cellulosic fibers, polyester fibers, polyamide fibers, polyolefin fibers, etc. The base filter fibers may be either man-made or of natural origin. In one embodiment, glass fibers are provided as base fibers. In another embodiment, pulp fibers are provided as base fibers.

The base filter fibers have a diameter that is similar to or substantially greater than the diameter of the CF provided in the filter media. For example, the base filter fibers may have a diameter of about 0.1 μm to about 100 μm. The filter medium formed from combining at least the CF disclosed herein and the base filter fibers may be used, for example, to capture particles from a fluid flowing through the media. The fluid may be a gas, such as air, or a liquid, such as water, oil or fuel.

It has been observed that a plurality of CF being placed in proximity of one another form strong hydrogen bonds. This self-bonding ability allows the CF to act as a binder, thereby entrapping and holding together the base filter fibers that are included in the filter medium. For example, CF forms hydrogen bonds amongst themselves when dried from a dilute suspension that includes CF and base filter fibers.

In some examples, the filter medium formed can be substantially free of binders due to the CF providing sufficient strength to the filter medium.

The degree of hydrogen bonding of the CF may be adjusted. For example, the amount of exposed hydrogen bonds available for self-bonding may depend on a choice of material for filament production and the choice of the filament manufacturing process parameters.

Furthermore, the CF may entangle amongst themselves. While not wishing to be limited by theory, the entanglement may be due, for example, to the long length of the CF and/or the high aspect ratio of the CF. While not wishing to be limited by theory, the entanglement may also be due to the high flexibility of the CF. FIG. 2B illustrates the long length and high aspect ratio of the filaments. The arrows in FIG. 2B point to different portions of an individual cellulose filament.

The CF may also entangle with the larger base filter fibers. While not wishing to be limited by theory, the entanglement may also be due to the long length of the CF, high aspect ratio of the CF and/or the high flexibility of the CF. For example, the CF may wrap around the larger base filter fibers. This entanglement and wrapping around of the CF with the base filter fibers further increases holding together of the base filter fibers.

In various exemplary embodiments where the base filter fibers are formed of cellulose, the CF may further form hydrogen bonds with the cellulose base filter fibers.

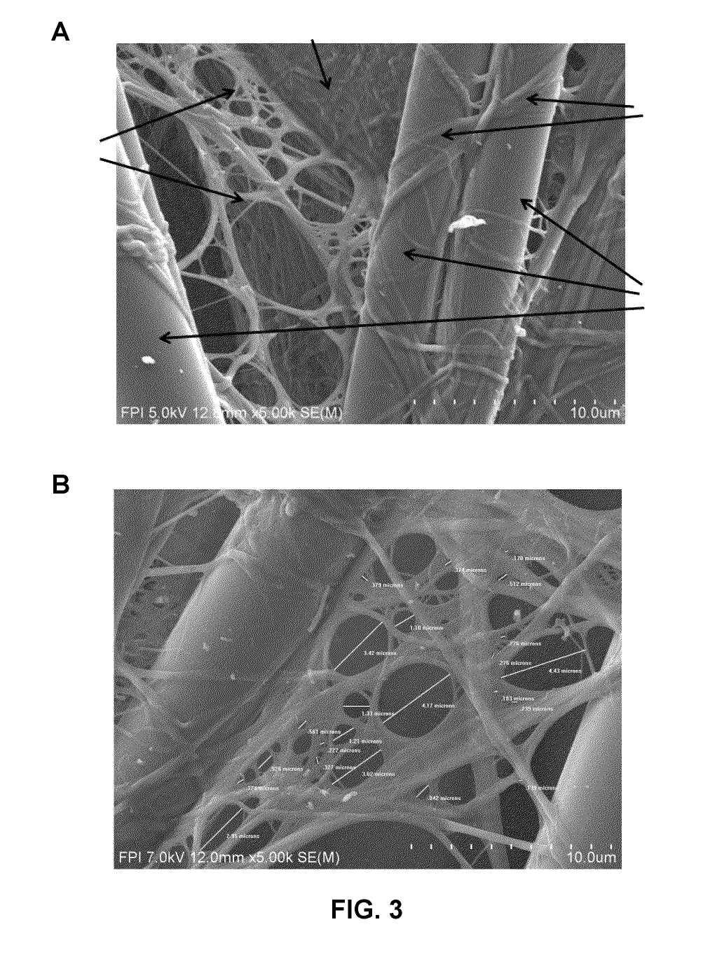

It has been observed that in various exemplary embodiments, multiple CF hydrogen bond and coalesce locally to form web-like structures or film-like structures (see FIG. 3A). The film-like structures have low thicknesses but can be relatively large in the other dimensions. These film-like structures can drastically increase the path length of fluids moving through the filter medium. As a result, fluids passing through the filter medium have a more tortuous path thereby increasing the chance of particle capture. The degree of coalescence of the filaments can be controlled by adjusting the amount of filaments in the filter composition, by using filaments of different grades or by pre-treating the filaments mechanically or with chemicals and possibly heat. The hydrogen bonding of the CF, the entanglement of the CF and the coalescence of the CF affect various properties of the filter medium that is formed. Properties affected include pore geometry, pore size, tortuosity, permeability, filtration efficiency, dust holding capacity and mechanical properties such as stiffness and wet and dry tensile strength.

Referring now to FIG. 3A, therein shown is an electron micrograph of a portion of a glass microfiber filter medium according to one example. It will be appreciated that FIG. 3A shows a plurality of large base filter fibers being held together with the CF. The CF is entangled with the larger base filter fibers. The top two arrows at the right hand side of the image point to some CF wrapping around the outer surface of the larger glass microfibers. Moreover, some of the CF extend between two or more base filter fibers, thereby entrapping and holding the base filter fibers together. Furthermore, FIG. 3B as well as the arrows at the left hand side of FIG. 3A show local coalescence of CF to form a web-like structure and further improve structural bonding of the base filter fibers. This web-like structure comprises a combination of individual filament segments and partially coalesced filaments. Because of their very small width, these individual filament segments and partially coalesced filaments contribute significantly to the overall filtration efficiency of the filter media. FIG. 3B shows the dimensions of some pores in one such web-like structure.

Because of the cellulose filaments' very high aspect ratio, long length and high number of exposed hydroxyl groups, various portions of a single filament can assume different physical forms in the media. Some portions can entangle and wrap around multiple base filter fibers, and some portions can partially coalesce with other filaments to create web-like and film-like structures, all of which will contribute to the properties of the filter media.

According to various example processes for forming a filter medium, a wetlaid process similar to papermaking can be applied. For example, a plurality of base filter fibers and a plurality of CF are uniformly distributed and suspended in a dilute suspension. The filter medium is then formed by draining the suspension through a forming fabric or mesh.

The filter medium is then dried, thereby causing hydrogen bonds between the CF and partial coalescence of the CF. The CF also becomes entangled with the base filter fibers, including wrapping around of some of the CF with the base filter fibers.

According to various exemplary embodiments, the filter medium includes one layer that is formed of base filter fibers combined with uniformly distributed CF.

According to other exemplary embodiments, the filter medium includes a plurality of layers, wherein the CF in a first layer and the CF in an additional layer have different properties. The CF in the first layer and the additional layer may vary in dimension, dosage and/or grade. For example, the first layer corresponds to an upstream layer in the filter medium and the additional layer corresponds to a downstream layer in the filter media.

For example, geometry, density and/or sizes of the pores of the filter medium may be varied. The varying of the geometry, density and/or sizes of the pores may be due to the small diameter and high specific surface of the CF and its ability to form hydrogen bonds.

For example, the degree of coalescence of the CF and their propensity to self-bond may be varied. For example, the electric charge carried by the CF may be varied. For example, the tensile strength of the filter medium may be varied. For example, the filtration efficiency of the filter medium may be varied. For example, the permeability of the filter medium may be varied. For example, the dust holding capacity of the filter medium may be varied. For example, the amount of carboxyl ion concentration in the filter medium may be varied. For example, the hydrophobicity or hydrophilicity of the filter medium may be varied.

Properties of the filter medium may be varied by controlling the grade of the CF that is combined with the base filter fibers. For example, the density and average pore size may be controlled.

Properties of the filter medium may be varied by controlling the dosage of CF that is combined with the base filter fibers. For example, the dosage may be varied by percentage of CF by weight, based on a total weight of the CF and the base filter fibers.

Properties of the filter medium may be varied by adding CF to lower the grammage of the filter medium while achieving a desired filtration efficiency at a given pressure drop.

Properties of the filter medium may be varied by controlling the dimensions of the CF that is combined with the base filter fibers, such as length, width, thickness and/or aspect ratio.

Properties of the filter medium may be varied by controlling the dimensions of the base filter fibers, such as length, diameter, and/or aspect ratio.

Properties of the filter medium will depend on the method by which they are prepared such as wetlaid, foam-forming, or freezed-dried processes.

Properties of the filter medium may be varied by adding chemicals such as debonding agents that will prevent hydrogen bonding between the CF. Examples of debonding agents can include sizing agents, surfactants, lignin, fatty acids or tall oils.

Unless otherwise provided, CF4 was used in all tables and figures pertaining to examples. CF4 had an associated tensile index of 115 N·m/g of handsheets of pure CF at 20 g/m².

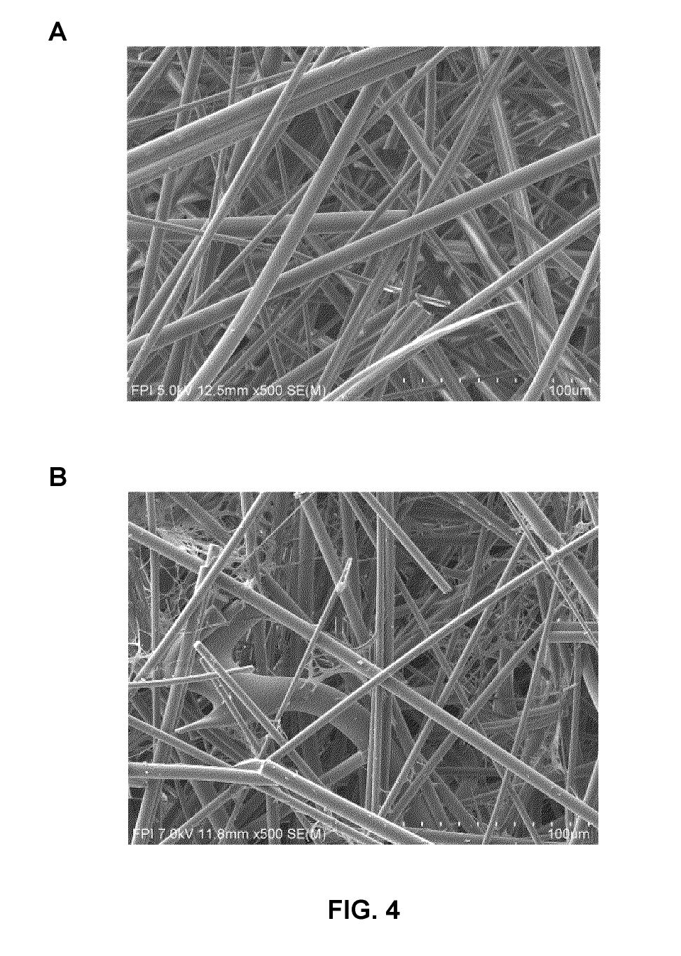

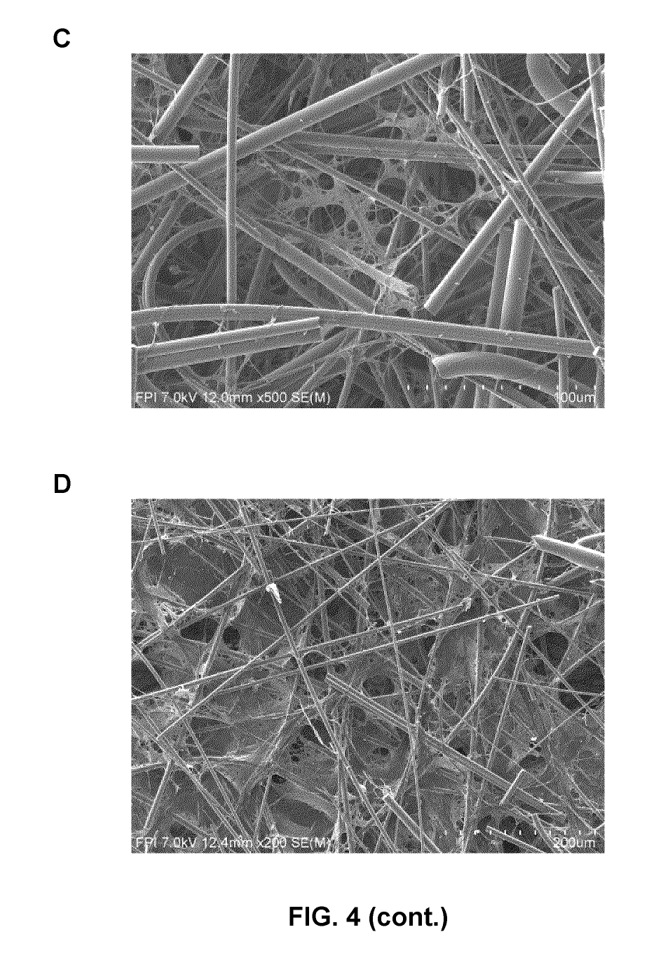

FIG. 4 shows electron micrographs of filter media showing the changes in pore structure for different dosages of CF by weight. In the example of FIG. 4, base filter fibers being glass microfibers were mixed with different dosages of CF produced from kraft pulp. The resulting suspension was diluted with water prior to filter making using a modified handsheet machine. The four surface micrographs shown correspond to filter media containing 0%, 2%, 5% and 10% of CF by weight, respectively.

It was observed that the CF increased the specific surface of the filter media while decreasing its average pore size. The result was an increase in filtration efficiency.

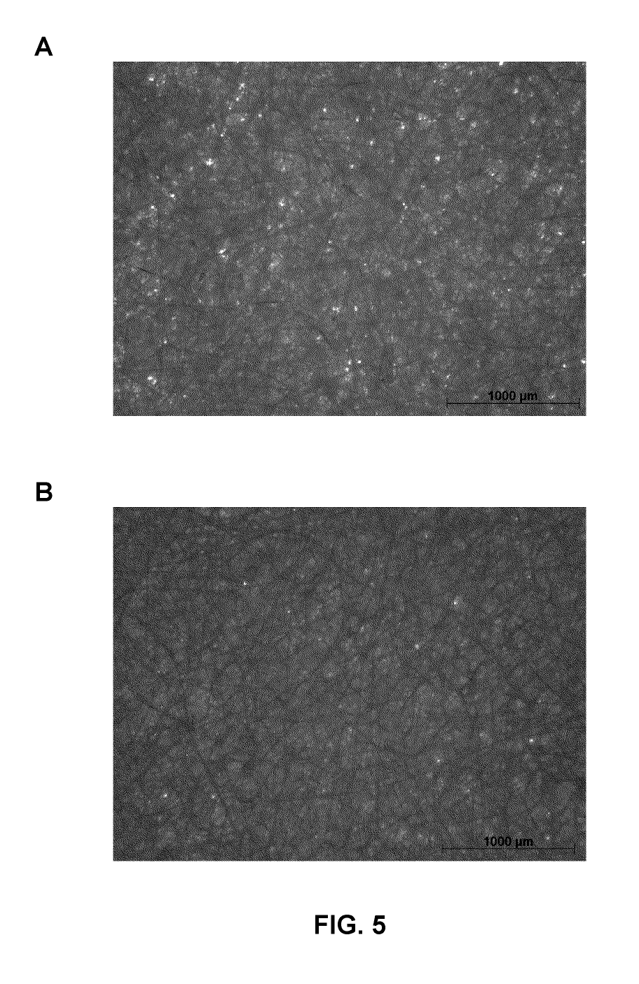

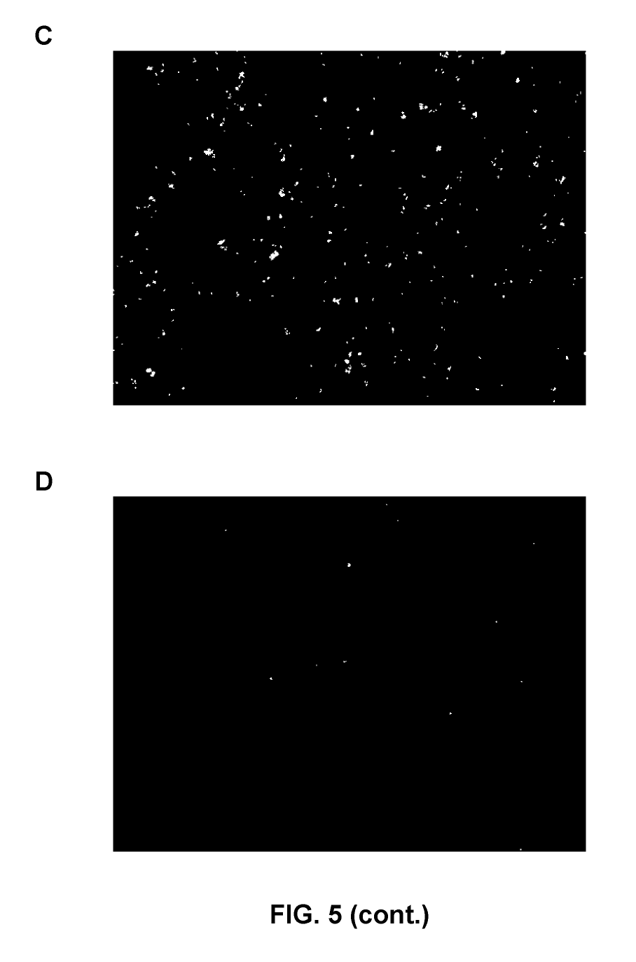

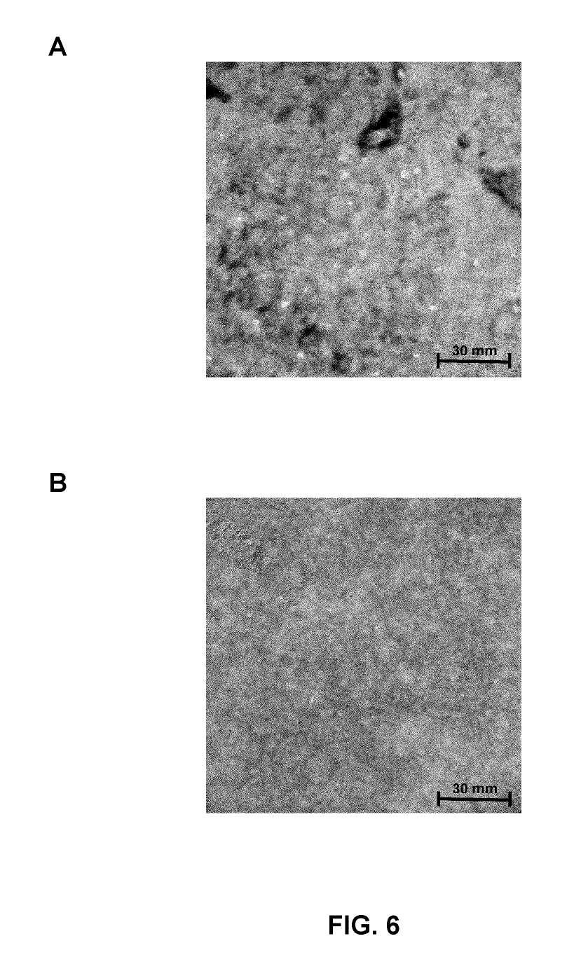

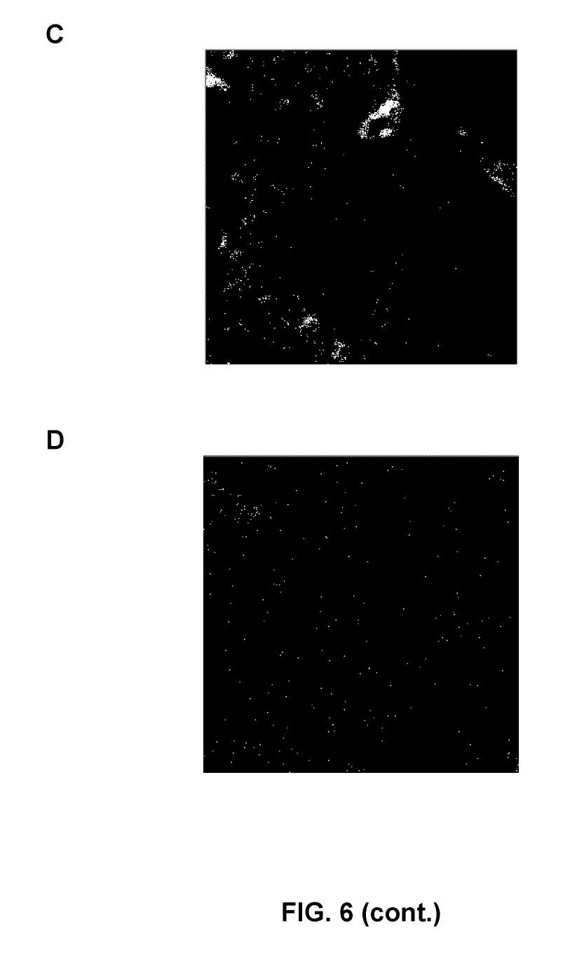

Handsheet filter media produced with CF showed improved formation, i.e., a more uniform mass distribution in the plane of the media, as compared to media made from glass fibers alone. This was observed over multiple length scales as illustrated in FIGS. 5 and 6. The optical micrograph shown in FIG. 5A corresponds to a filter media made from a blend of glass fibres without CF while that shown in FIG. 5B corresponds to the same filter media containing 4% CF. Both media were prepared at a grammage of 70 g/m². The two micrographs, which were taken in transmitted light, cover an area roughly equal to 9.5 mm². The media prepared without CF is clearly less uniform than the one prepared with 4% CF. In particular, the media prepared without CF is characterized by the presence of a large number of regions of low grammage which appear as white spots (of typical size between 10 and 50 μm) on the micrograph. Figures C and D show the regions of low grammage detected by a thresholding procedure. The detected regions cover 0.7% of the total imaged area for the media prepared without CF and only 0.04% of the total imaged area for the media prepared with 4% CF.

The same difference in uniformity between the two filter media can also be observed at a larger scale, as illustrated by the scanned images shown in FIGS. 6A and 6B. The area shown in both images is roughly 21000 mm². These media were scanned using reflected light so that regions of low grammage (typically of size between 100 and 10000 μm) appear as darker areas on the image. The regions of low grammage detected in the media prepared without CF (FIG. 6C) cover 1.27% of the total area scanned while they cover only 0.20% of the area scanned for the media prepared with 4% CF (FIG. 6D).

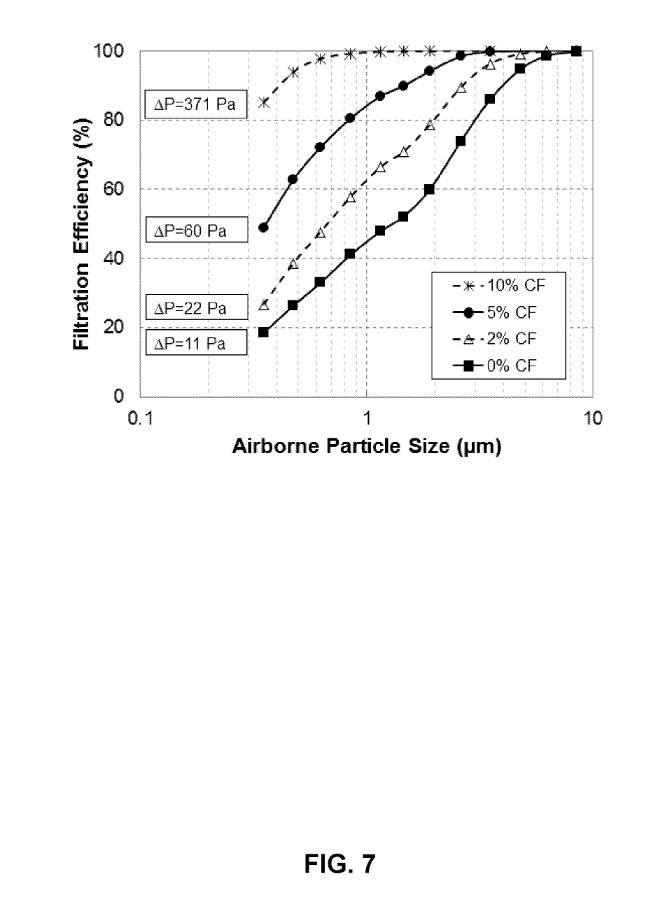

FIG. 7 shows graphs of air filtration efficiency curves measured for four filter media of grammage 200 g/m² made from glass fibers of mean diameter 5.5 μm combined with different dosages of CF. The dosages measured were 0%, 2%, 5% and 10% of CF by weight, respectively. The filtration efficiency increased with increasing CF dosage. In fact, the MERV (minimum efficiency reporting value) increased from 10 at 0% CF to 11, 13, and 15 at 2, 5 and 10% CF, respectively. The improvement in efficiency was accompanied by an increased resistance to air flow. The pressure difference measured across the filter at a flow rate of 10.5 ft/min ranged from 11 to 371 Pa, corresponding to CF dosage levels from 0 to 10% by weight. Specifically, there was a measured drop of 11 Pa at a dosage level 0% of CF by weight, 22 Pa at a dosage level of 2% of CF by weight, 60 Pa at a dosage level of 5% of CF by weight and 371 Pa at a dosage level of 10% of CF by weight. At a high CF addition of 10%, CF coalescence and formation of film-like structures dominated, closing the filter pores and causing a large increase in tortuosity of the filter medium. Because of that increase in tortuosity, mixtures of CF and base fibers may also be used for other purposes, for example, to attenuate the propagation of sound through walls and ceilings in residential and commercial buildings. Closing of the filter pores by CF coalescence also caused a large decrease in filter permeability.

In general, the resistance that a filter medium offers to the passage of air should be kept as low as possible. In examples disclosed herein, the resistance was controlled by controlling the level of bonding between the CF. At high CF contents, the larger glass microfibers no longer act to separate the CF and prevent self-bonding.

In addition to CF dosage in the filter, the level of self-bonding can also change with the grade of CF used, the use of chemicals, debonding agents, and filler additives, chemical pre-treatment of the CF, and heat pre-treatment. The level of self-bonding of the CF can also be controlled by changing the process used to form and to dry the filter medium.

It was further observed that the addition of CF also affected mechanical properties such as tensile strength and stiffness. Stiffness is important in applications requiring the filter medium to be pleated.

The strength and stiffness of filter media containing CF will depend on the total bonded area between the CF as well as the level of entanglement with the base filter fibres. It was observed that the strength and stiffness increased with an increase in CF dosage.

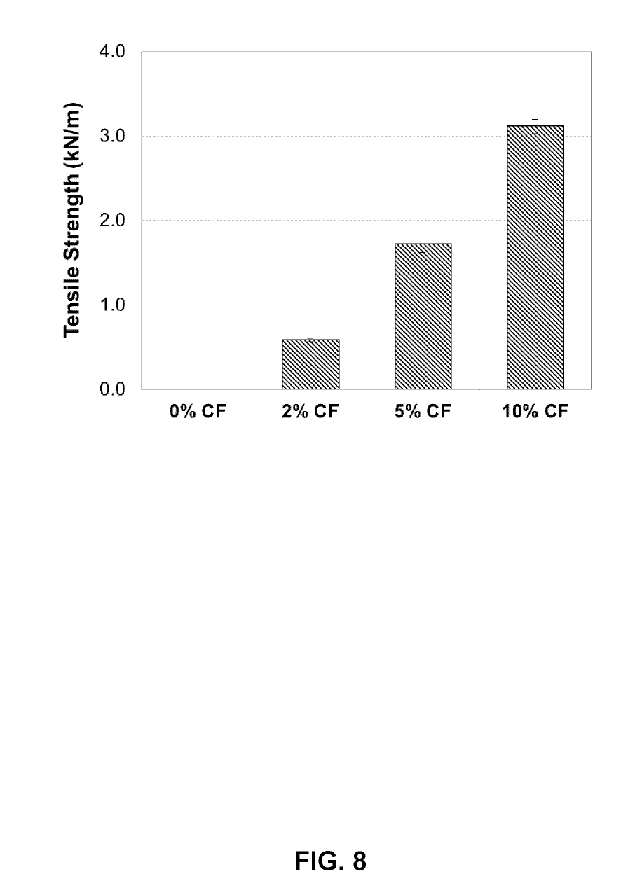

FIG. 8 illustrates a graph showing measured tensile strength for the four filter media of FIG. 7. These 200 g/m² filter media have base filter fibers being glass microfibers of mean diameter 5.5 μm combined with different dosages of CF. The dosages measured were 0%, 2%, 5% and 10% of CF by weight, respectively. The control filter medium (0% CF) made from glass microfibers had a very weak tensile strength nearing zero. This was in line with expectations, as filter strength comes exclusively from mechanical entanglement of the large base filter fibers. Typically, to counteract this weak structure, a binder such as latex or resin is added to such filters in relatively high proportions of often 3% to 25% by weight. Thermally bonded fibers can also be added in similar proportions for the same purpose. In some instances, the glass fiber medium may also be formed under very acidic conditions to produce some level of bonding between the fibers via acid attack. While binders impart the filter with the required mechanical properties, they usually do not enhance filtration performance.

In contrast, addition of CF to a filter medium of grammage 200 g/m² made from glass microfibers improved tensile strength to about 0.59 kN/m at a dosage level of 2% of CF by weight, about 1.7 kN/m at a dosage level of 5% of CF by weight, and about 3.1 kN/m at a dosage level of 10% of CF by weight.

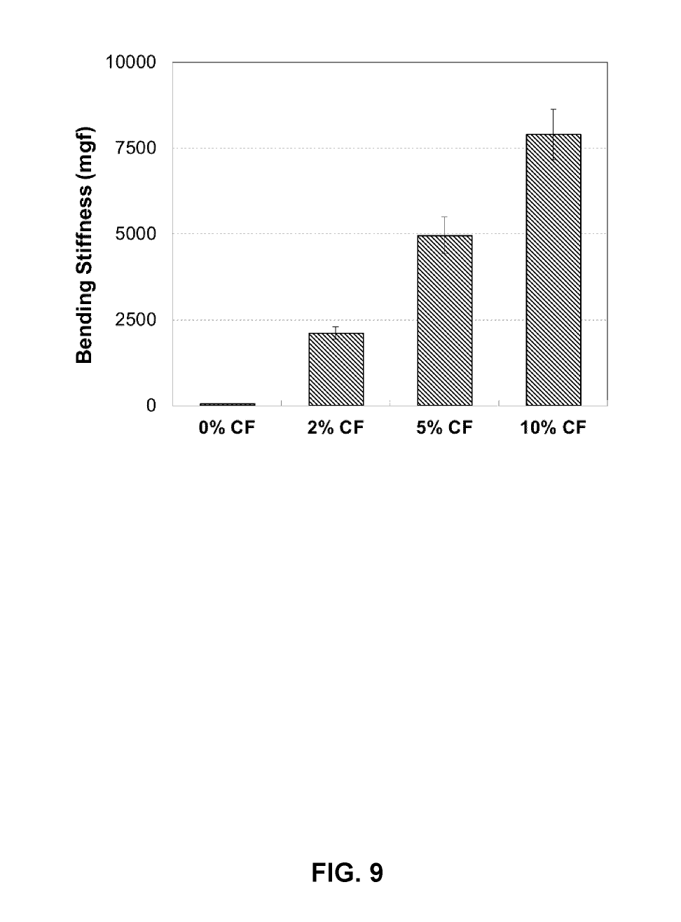

FIG. 9 illustrates a graph showing bending stiffness for filter media of grammage 200 g/m² having base filter fibers being glass microfibers of mean diameter 5.5 μm mixed with different dosages of CF produced from kraft pulp. The filtration efficiency curves and tensile strength for these four media were already shown in FIGS. 7 and 8, respectively. The dosages measured were 0%, 2%, 5% and 10% of CF by weight, respectively.

It will be appreciated that combining 2% CF by weight with the glass microfibers was enough to achieve stiffness values above 2000 mgf. It will be appreciated that the use of CF increases filtration efficiency while also improving mechanical properties, thereby reducing or eliminating the need to add binding material.

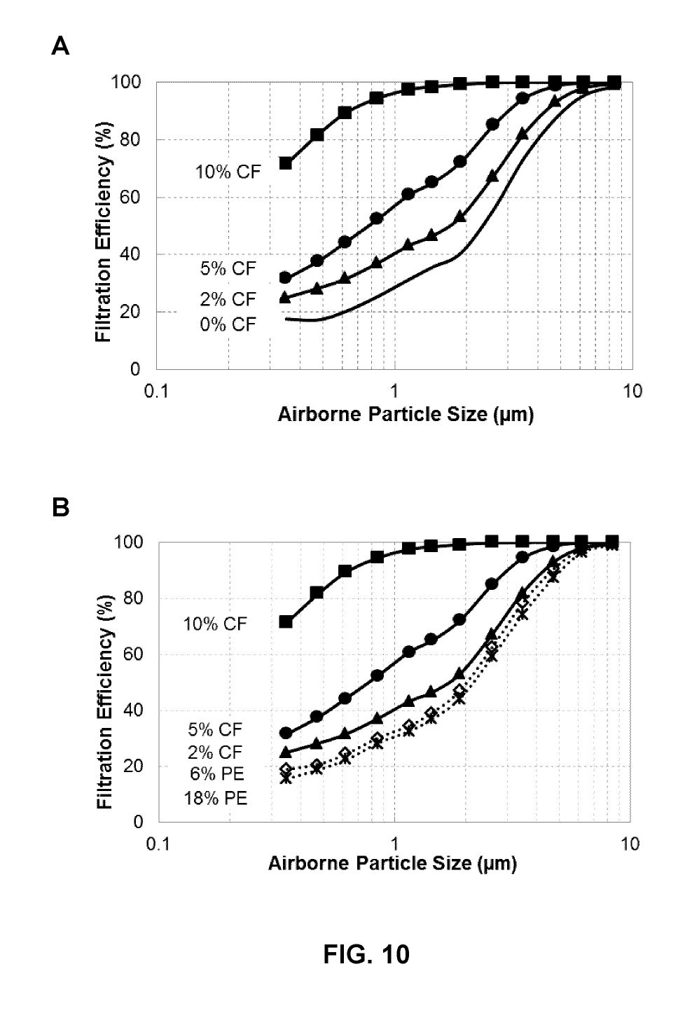

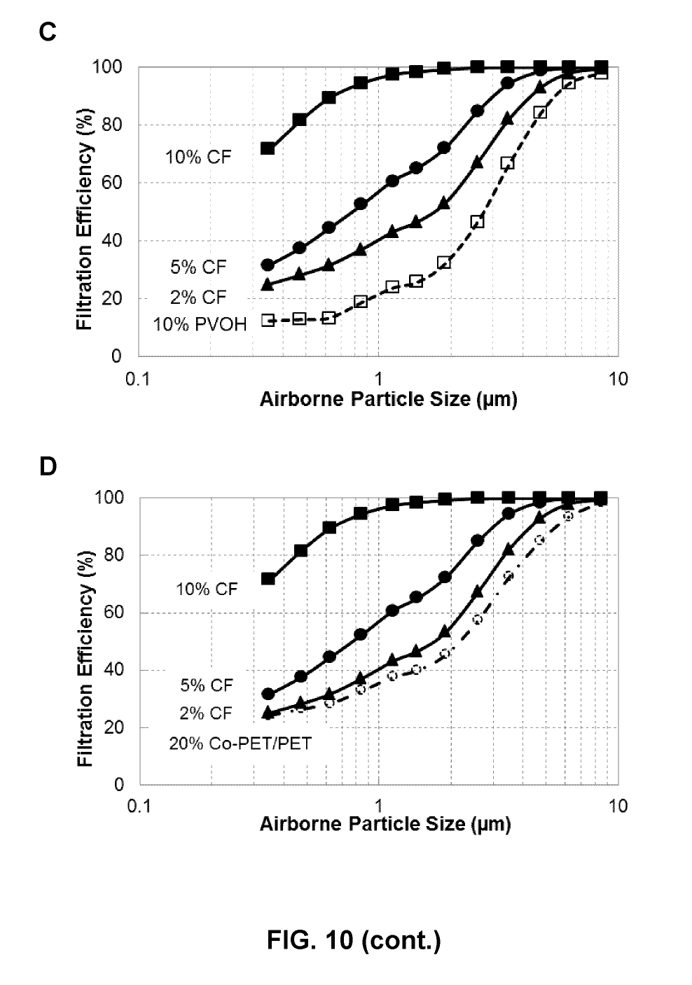

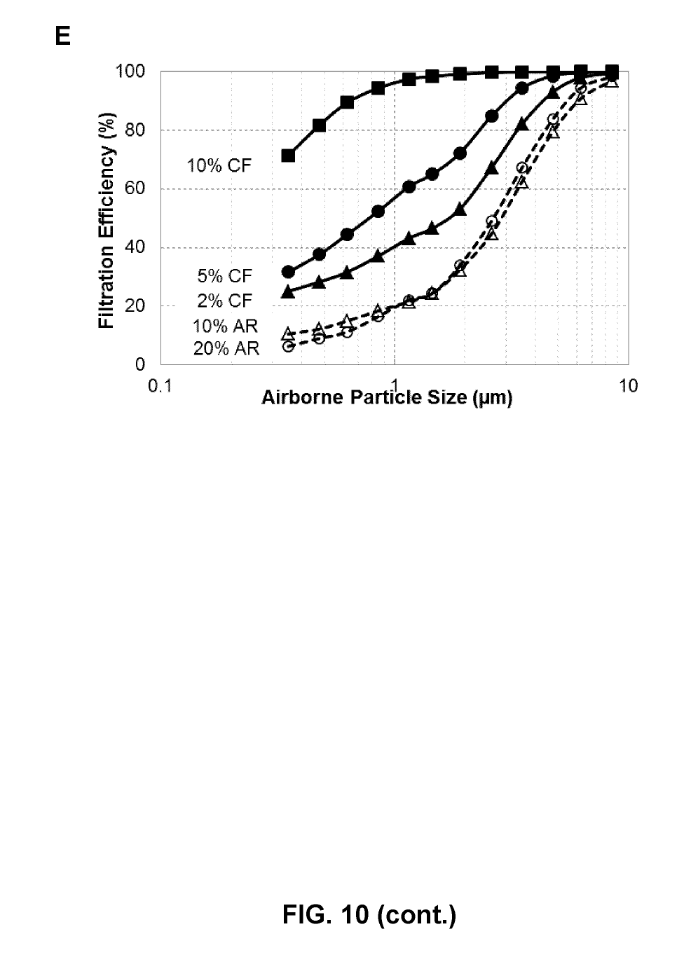

Filtration efficiency curves of filter media of grammage 100 g/m² made from glass microfibers of mean diameter 5.5 μm and varying amounts of CF are shown in FIG. 10A. The filtration efficiency of the filter medium increased with CF content, in agreement with the results obtained at 200 g/m² shown in FIG. 7. In addition, the MERV rating increased from 9 to 10 to 11 and then to 14 with increasing CF dosages of 0, 2, 5 and 10%, respectively. The filtration efficiency curves of FIG. 10A are also shown in FIGS. 10B, 100, 10D and 10E and compared to the filtration efficiency of filter media of identical grammage made from mixtures of the same glass fibers but different binding materials. In FIG. 10B, the binding material was thermally bonded fibrillated polyethylene fibers of 5 μm mean diameter. In FIG. 100, the binding material was PVOH fibers of mean diameter 11 μm. In FIG. 10D, the binding material was thermally bonded Co-PET/PET bicomponent fibers. In FIG. 10E, the binding material was a water-based acrylic resin. As shown in FIGS. 10B, 10C, 10D and 10E, the filtration efficiency of the CF-containing filter media is clearly superior to that of the filter media containing thermally bonded PE or PVOH fibers or Co-PET/PET bicomponent fiber or the acrylic resin.

The pressure drops measured across the different filter media shown in FIG. 10 A-E are summarized in Table 4. It can be seen from the table that the pressure drop measured across the filter media containing 2% CF is essentially the same as that measured across the filter media containing the various binding materials. However, the filtration efficiency of the filter media containing 2% CF was clearly superior to the filter media containing the other binding materials as seen in FIGS. 10 B, C, D and E.

Table 4 also provides pressure drops measured across filter media of different grammage: 200 g/m² in FIG. 7 and 100 g/m² in FIG. 10 A-D. The presence of even 2% CF provided enough strength to the filter to permit not only handling but also measurement of the filter properties. In addition, the pressure drop of 100 g/m² filter media containing 2% CF is lower than for a filter media without CF at double the grammage while its filtration efficiency is higher for submicron airborne particles. A layered filter media with different amounts of CF in each layer may be interesting.

TABLE 4
Pressure drop (ΔP) across filter media measured at a
flow velocity of 10.5 ft/min. The 100 g/m² and 200 g/m² filter
media were made from glass microfibers of 5.5 μm mean
diameter and various amounts of CF, PE fibers, PVOH fibers,
Co-PET/PET bicomponent fibers or acrylic resin.

Pressure Drop (Pa)

| Additive | Dosage (%) | 100 g/m² | 200 g/m² |
|---|---|---|---|
| CF | 0 | 5 | 11 |
| | 2 | 7 | 22 |
| | 5 | 15 | 60 |
| | 10 | 158 | 371 |
| PE Fibers | 6 | 7 | — |
| | 18 | 8 | — |
| PVOH Fibers | 10 | 7 | — |
| Co-PET/PET | 20 | 6 | — |
| Bicomponent Fibers | | | |
| Acrylic Resin | 10 | 7 | — |
| | 20 | 6 | — |

— No samples prepared at 200 g/m².

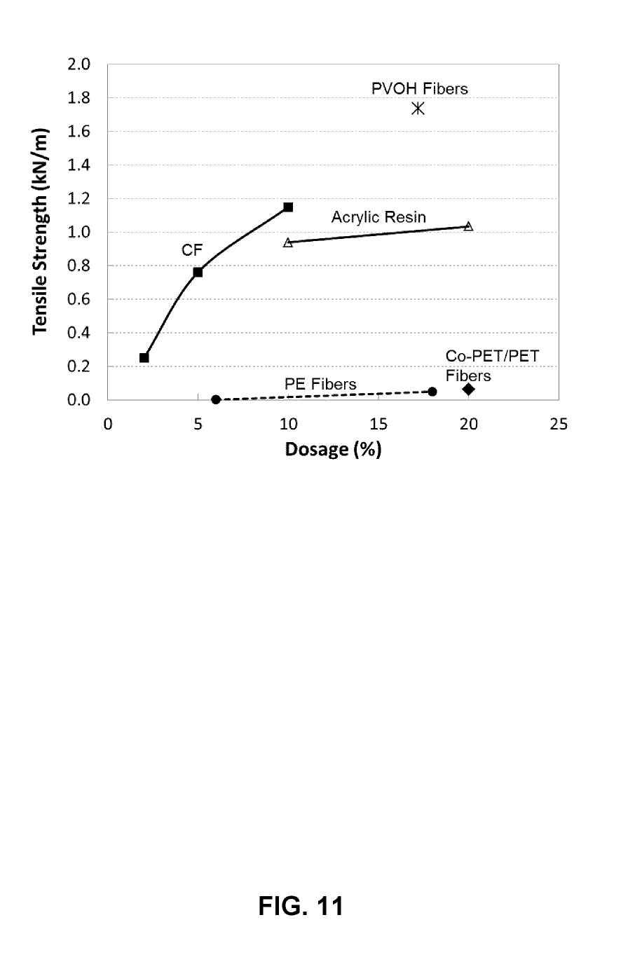

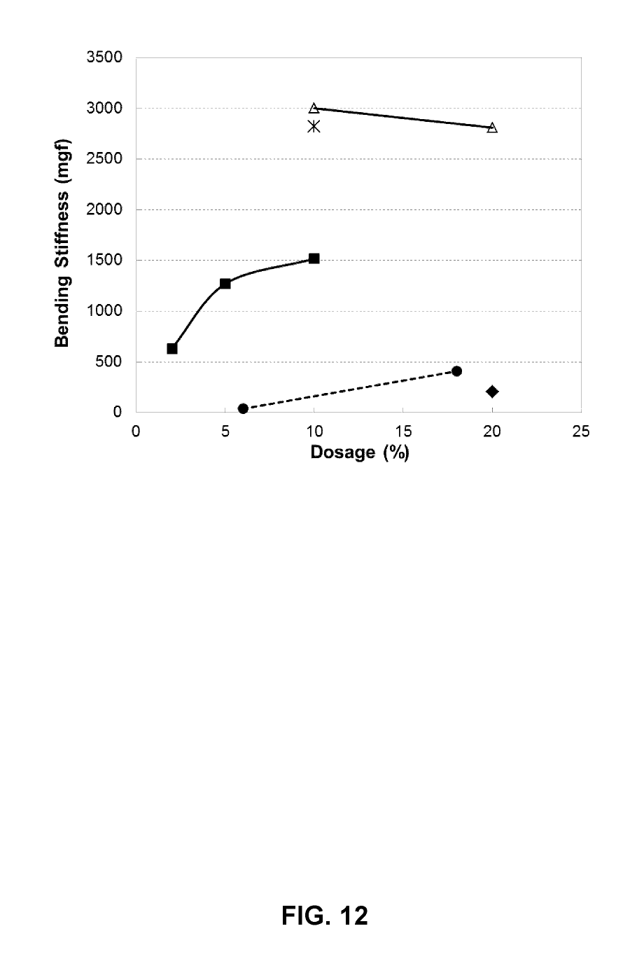

The tensile strength measured on the 100 g/m² filter media made from glass microfibers and various amounts of either CF, thermally bonded PE fibers, PVOH fibers, thermally bonded Co-PET/PET bicomponent fibers or acrylic resin are shown in FIG. 11. The tensile strength of filter media containing CF was clearly higher than the tensile strength measured on filter media containing the thermally bonded polyethylene fibers or thermally bonded Co-PET/PET bicomponent fibers. In particular, a filter medium containing 2% CF by weight was stronger than a filter medium containing as much as 18% thermally bonded polyethylene fibers or 20% thermally bonded Co-PET/PET bicomponent fibers. A filter medium containing 10% CF also had a higher tensile strength than a filter medium made from the same glass microfibers but containing instead 10% acrylic resin. The tensile strength of the filter medium containing 10% CF by weight was higher than that of a filter medium containing 20% acrylic resin. However, it was observed to be lower than the tensile strength of filter media containing 10% by weight of PVOH fibers. Bending stiffness was also measured for all the filter media of FIG. 11 and the results are shown in FIG. 12. The bending stiffness of filter media containing up to 10% CF was higher than that of filter media containing thermally bonded polyethylene fibers or thermally bonded Co-PET/PET bicomponent fibers. However, it was lower than the bending stiffness of filter media containing at least 10% PVOH fibers or acrylic resin.

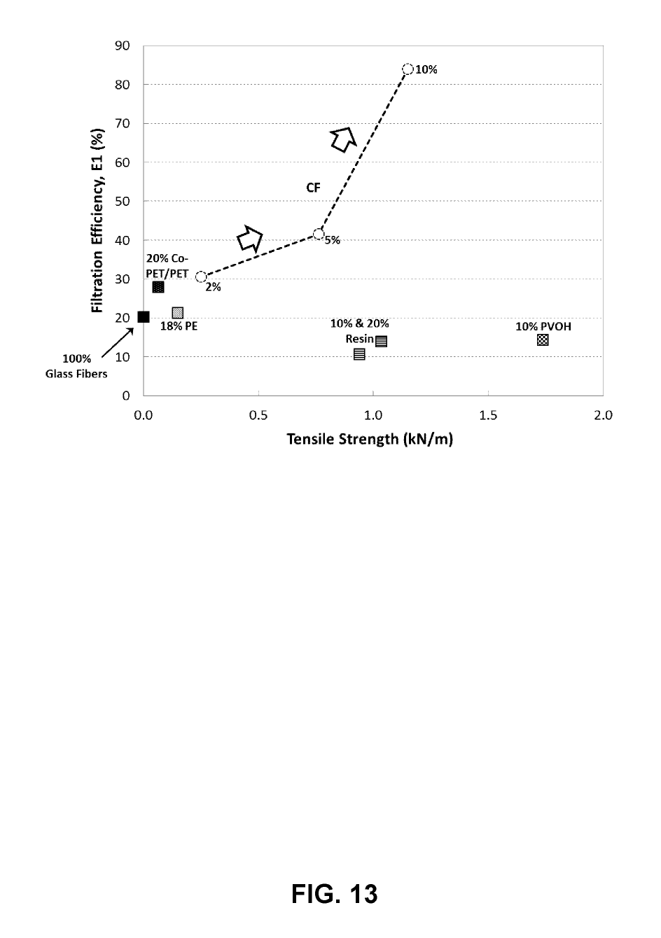

FIG. 13 illustrates that CF distinguish themselves from conventional binders as they improve both the filtration efficiency and the tensile strength of filter media. Like for FIGS. 11 and 12, in the example shown in FIG. 13, the media, of grammage 100 g/m², was made from glass microfibers of mean diameter 5.5 microns. The performance of CF was compared to that of different binding materials such as PVOH fibers, PE fibers, Co-PET-PET bicomponent fibers and acrylic resin. The filtration efficiency E₁ corresponds to the average filtration efficiency measured at four different airborne particle sizes: 0.35, 0.475, 0.625 and 0.85 μm.

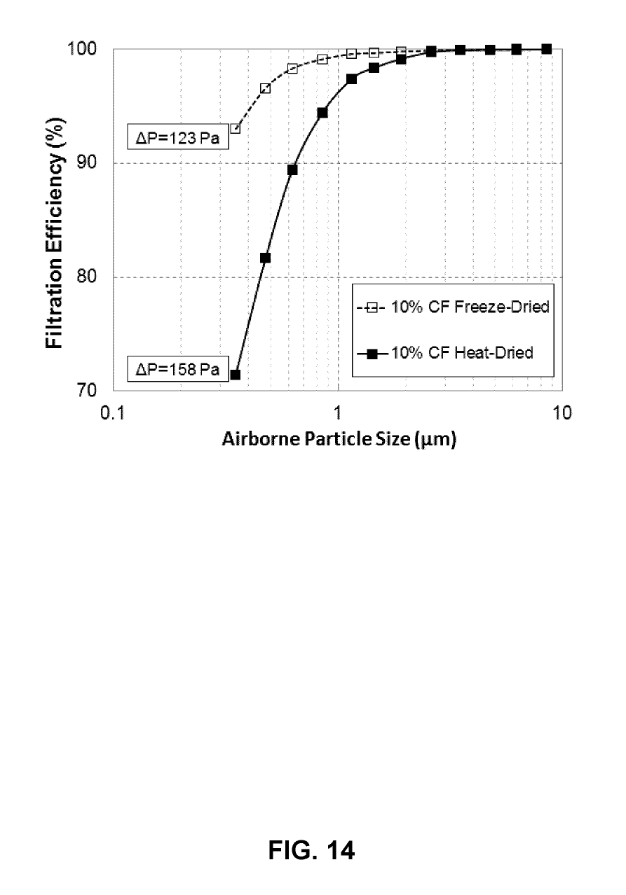

One approach for reducing the level of bonding between cellulose filaments in the filter medium is to use a freeze-drying process to remove water from the filter medium after the forming and pressing steps. Specifically, the filter medium is first immersed in a bath of liquid nitrogen to solidify the water still present within its structure. The filter medium is then placed in a freeze-dryer, where the water is eliminated by sublimation. That process avoids the capillary forces generated when the water is dried from the liquid state. Those capillary forces induce attractive forces between fibers in the network and lead to hydrogen bonding when the latter are made of cellulose. Thus, freeze-drying of a filter medium containing CF is expected to improve filtration performance at the expense of mechanical strength. FIG. 14 compares the filtration performance of two filter media made from a mixture consisting of 90% glass microfibers of mean diameter of 5.5 μm and 10% CF. The target grammage in both cases was 100 g/m². One of the media was dried by heat while the other was freeze-dried after being immersed in nitrogen. The filter medium that was freeze-dried had higher filtration efficiency than the filter medium produced by conventional means and it also had a lower pressure drop and thus higher permeability. As expected, however, the mechanical properties of the filter produced by freeze-drying are not as good as those of the filter medium that were dried by heat as shown in Table 5.

TABLE 5
Tensile strength and bending stiffness of heat-dried
and freeze-dried filter media made from glass microfibers
of 5.5 μm mean diameter and containing 10% CF.

| | Tensile Strength | Gurley |
|---|---|---|
| Drying Method | (kN/m) | Stiffness (mgf) |
| heating | 1.15 | 1518 |
| freeze-drying | 0.75 | 813 |

While the base fibers in the previous examples were all made from glass, it is also possible to use CF in combination with fibers made from other materials such as cellulose. Table 6, below summarizes the properties measured on filter media produced from a mix of CF and NBSK fibers with a high curl index. The filter media of 130 g/m² contained 5 or 10% by weight of CF. The table provides the air filtration efficiency at an airborne particle size of 0.35 μm and a flow rate of 10.5 ft/min as well as the pressure drop measured at the same flow rate. The mean flow and maximum pore size, which are often used to characterize oil and fuel filters, are also listed in the table. Table 6 also shows the mechanical properties and caliper of the filter media.

Addition of 10% CF to the cellulosic fibers more than doubled the capture of particles of 0.35 μm in diameter. Addition of 10% CF by weight also increased filter medium tensile strength and bending stiffness by 75% and 18% respectively while decreasing the thickness of the filter by 25%. Finally, the mean flow and maximum pore size obtained by porometry decreased by 78% and 71% respectively at the maximum CF dosage.

TABLE 6
Mechanical properties and filtration performance of 130 g/m²
cellulosic filter media made from mixtures of NBSK curly fibers and CF.

| | Capture | | Mean | | | | |
|---|---|---|---|---|---|---|---|
| CF | Efficiency | Pressure | Flow | Maximum | | Tensile | Gurley |
| Dosage | at 0.35 μm | Drop | Pore Size | Pore Size | Caliper | Strength | Stiffness |
| (%) | (%) | (Pa) | (μm) | (μm) | (μm) | (kN/m) | (mgf) |
| 0% | 41 | 27 | 28.6 | 56.4 | 681 | 0.46 | 699 |
| 5% | 60 | 126 | 15.2 | 28.6 | 534 | 1.19 | 992 |
| 10% | 89 | 547 | 6.3 | 16.2 | 508 | 1.87 | 855 |

As discussed previously, CF can be produced from a variety of fiber sources and under a wide range of manufacturing conditions. The physical and mechanical properties of the CF will change accordingly and so will its impact on the properties of the filter medium to which it is added. The results presented in Table 7 illustrate this point. The 200 g/m² filter media in these examples were all produced from a mixture consisting of 90% by weight glass microfibers (GMF) combined with 10% CF made from different fiber sources. Four grades of CF, CF1-CF4, were produced from NBSK. CF7 was produced from a commercial dissolving pulp while CF8 was produced from thermo-mechanical pulp (TMP). CF1 to CF4 had increasing energy applied during refining, with CF1 having the lowest energy. Results obtained with these first four CFs clearly show the impact of varying refining conditions on the resulting properties of the filter: the higher the energy for a given starting pulp, the higher the stiffness, strength and capture efficiency of the filter and the lower the permeability.

TABLE 7
Mechanical properties and filtration performance of 200 g/m² filter
media made from glass microfibers of 5.5 μm mean diameter and
containing 10% CF produced from different fibre sources.

| | | Capture | | | |
|---|---|---|---|---|---|
| | | Efficiency | Pressure | Tensile | Gurley |
| | | at 0.35 μm | Drop | Strength | Stiffness |
| CF Fiber Source | CF ID | (%) | (Pa) | (kN/m) | (mgf) |
| NBSK | CF1 | 25 | 20 | 0.41 | 1447 |
| | CF2 | 52 | 64 | 1.68 | 4490 |
| | CF3 | 66 | 135 | 2.41 | 6436 |
| | CF4 | 85 | 371 | 3.11 | 7894 |
| Dissolving Pulp | CF7 | 41 | 47 | 1.47 | 3752 |
| TMP | CF8 | 70 | 118 | 1.61 | 5227 |

As for the impact of fiber source, results in Table 7 show that, for the particular combination of 90% by weight glass microfibers and 10% CF, the filtration performance obtained with the CF produced from spruce wood chips is slightly better than that obtained with CF3 produced from NBSK pulp. However, CF3 made from NBSK had a greater impact on the mechanical properties of the filter such as tensile strength and stiffness than that produced from wood chips. This tendency is similar to that obtained when comparing paper produced from NBSK versus that produced from thermomechanical pulp (TMP). While not wishing to be limited by theory, the reasons that paper or CF made from NBSK has greater mechanical strength than TMP may include the longer fiber length of the NBSK furnish and the lower amounts of hydrophobic extractives such as fatty acids that are known to prevent hydrogen bonding.

Compared to NBSK or TMP, dissolving pulp has little or no hemicellulose associated with the fiber. As such, the CF produced from dissolving pulp does not reinforce the mechanical properties of the filter as much as the CF2 produced from NBSK with slightly lesser energy. Hemicelluloses improve fiber to fiber bonding. Use of a CF with low hemicellulose content can reduce fiber to fiber bonding and give a filter with a lower pressure drop. Filter media of glass microfibers and CF from dissolving pulp had lower filtration efficiency but higher permeability than the filter media obtained with the CF2 produced from NBSK.

As described herein, a filter medium formed from combining a plurality of base filter fibers with a plurality of CF allows the filter medium to have various advantageous properties. While not wishing to be limited by theory, these advantages may be due in part to one or more of the small width and thickness of CF, high aspect ratio of CF, flexibility of CF, hydrogen-self bonding of CF, entanglement of CF and coalescence of CF. The advantages obtained include one or more of control of pore geometry, pore size, total surface area leading to targetable filtration efficiency through control of CF dosage and grade; improved mechanical properties such as dry strength, tensile strength and stiffness, improved resistance to manipulation such as scoring and pleating, production of thinner filter media leading to lower volume filters and higher pleats density, ability of CF to hold base fibers and fillers via self-bonding and mechanical entanglement, reduction or elimination of binders and saturation chemicals in the filter medium, possibility to add chemically modified CF to impart features such as anionic or cationic CF or hydrophobic or hydrophilic CF.

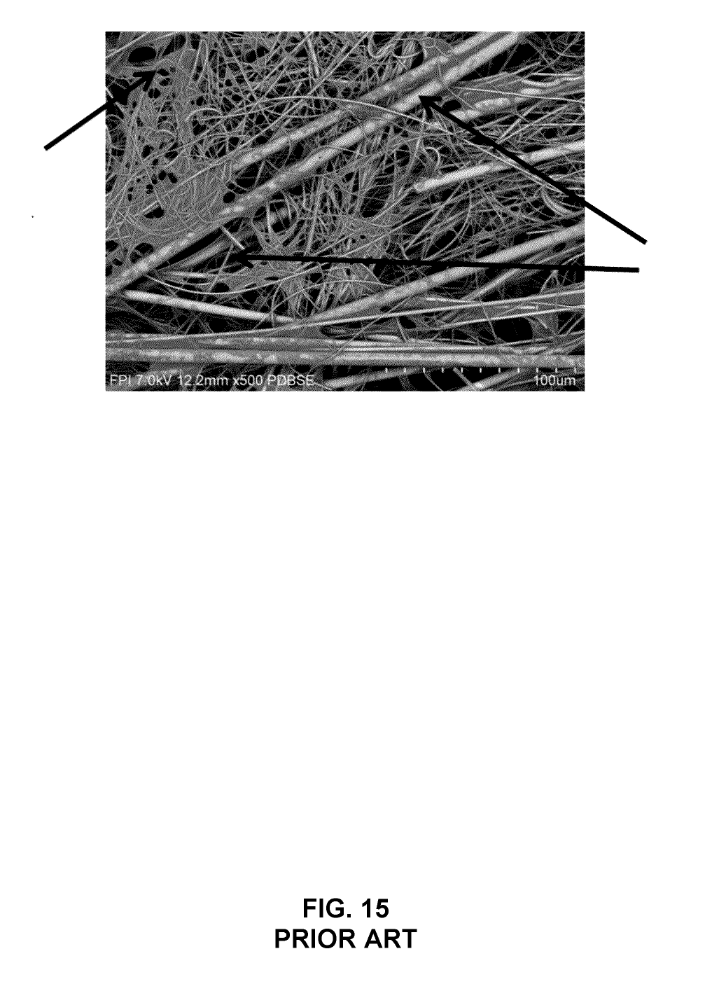

FIG. 15 shows an electron micrograph of a portion of a commercial wetlaid glass fiber filter media rated MERV 14. It will be appreciated that FIG. 15 shows a plurality of large and small glass fibers with some binder. In general, glass fibers create mechanical entanglement between themselves. This phenomenon is accentuated with glass fibers of smaller diameter. However, unlike CF, glass fibers don't form hydrogen bonds amongst themselves. Therefore, a binder is usually added to the composition of the medium in order to improve its mechanical integrity. It will also be appreciated in FIG. 15 that the binder is preferentially located between the glass fibers of small diameter, thereby reducing the amount of fiber surface area exposed to air and available for airborne particle capture. As a result, binder addition may have a negative impact on filtration performance.

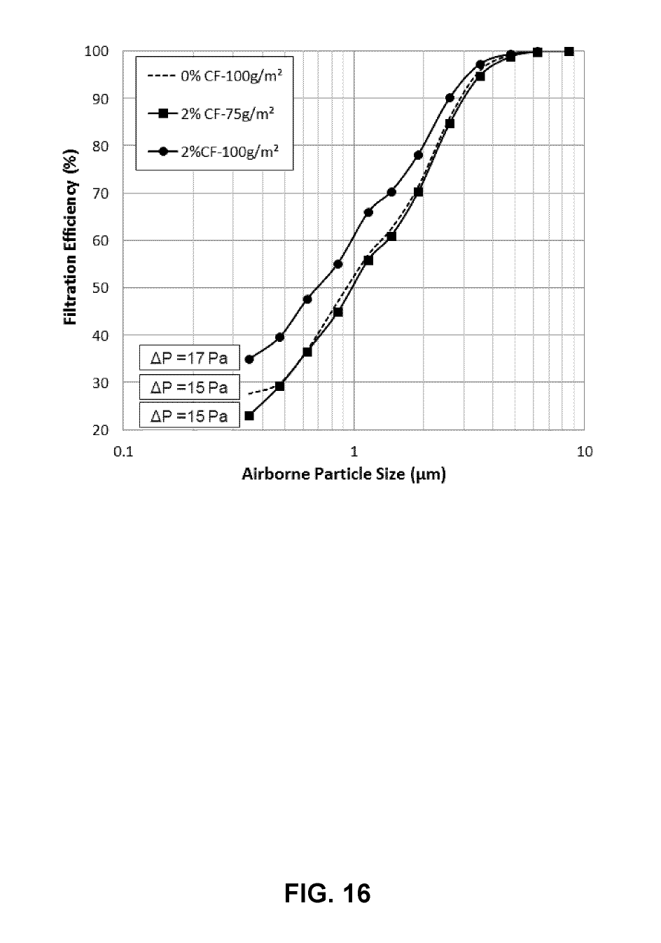

FIG. 16 shows that addition of 2% CF to a media composition can reduce grammage by 25% without affecting filtration performance. All media in that particular example were made from glass microfibers of mean diameter 4.0 μm. Media made exclusively from glass microfibers were prepared at a grammage of 100 g/m², Media comprising 2% CF by weight were prepared at two different grammages, 100 and 75 g/m², respectively. FIG. 16 shows that the filtration efficiency curve and the pressure drop measured across the 100 g/m² samples prepared without CF are almost identical to those of the media prepared with 2% CF at 75 g/m². In particular, the MERV rating of both media is 11. The figure also shows that, at a grammage of 100 g/m², the media prepared with 2% CF has significantly higher filtration efficiency than the corresponding media prepared without CF.

The positive impact of CF addition on mechanical properties is illustrated in Table 8. The 100 g/m² samples made exclusively from glass microfibers were too weak to withstand testing. By contrast, media comprising 2% CF by weight had tensile strength of 0.23 and 0.34 kN/m at grammages of 75 and 100 g/m², respectively. In this, as in several previous examples discussed herein, the presence of CF was observed to increase both the filtration efficiency and the mechanical properties of the filter media.

TABLE 8
Mechanical properties of filter media made from glass microfibers
of 4.0 μm mean diameter and comprising 0 or 2% CF.

| | Tensile Strength | Gurley Stiffness |
|---|---|---|
| Sample ID | (kN/m) | (mgf) |
| 0% CF, 100 g/m² | NA* | NA* |
| 2% CF, 75 g/m² | 0.23 | 242 |
| 2% CF, 100 g/m² | 0.34 | 403 |

*Not applicable; filter media made exclusively from glass microfibers were too fragile to be tested.

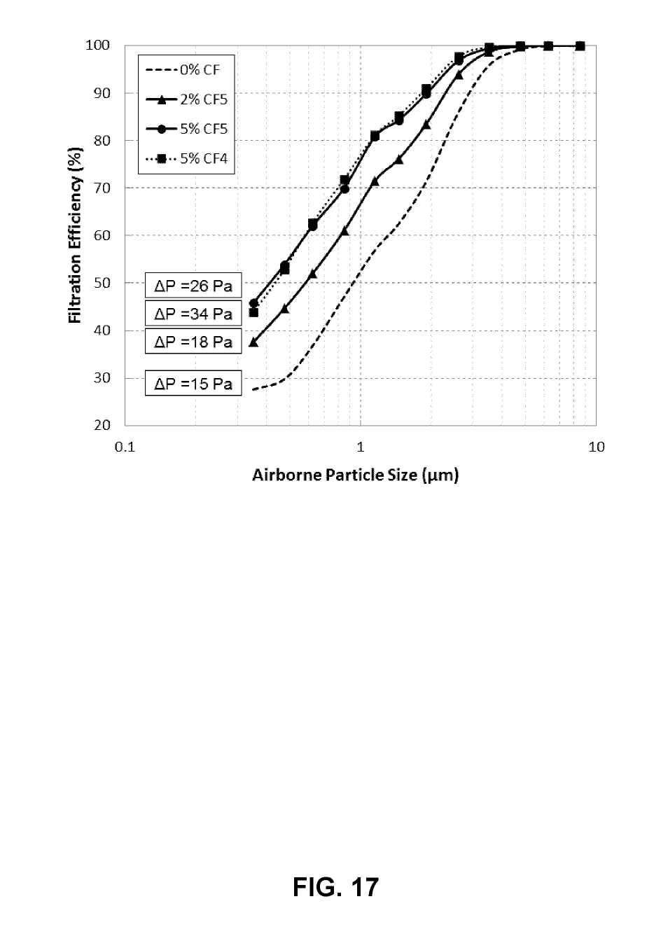

As was already shown in Table 7, the grade of the CF added to the filter media has an influence on both filtration performance and mechanical properties. In the example shown in FIG. 17, media of grammage 100 g/m² were prepared from glass microfibers of mean diameter 4.0 μm and varying amounts of CF4 or CF5. FIG. 17 shows that, at the same 5% addition level, media made with CF4 or with CF5 have similar filtration efficiency curves, but the media made with CF5 have a lower pressure drop (26 vs. 34 Pa) and a higher quality factor (0.024 vs. 0.017) (see Table 9). However, the tensile strength and bending stiffness of the filter media prepared with CF4 are higher than those prepared with CF5. It should also be noted that the quality factor of the samples prepared with CF5 are higher than those of media made exclusively from glass microfibers.

TABLE 9
Filtration performance and mechanical properties of 100
g/m² filter media made from glass microfibers of 4.0 μm mean
diameter and containing 0, 2 or 5% of different CF.

| | Capture | | | | |
|---|---|---|---|---|---|
| | Efficiency | Pressure | | Tensile | Gurley |
| | at 0.35 μm | Drop | Quality | Strength | Stiffness |
| Sample ID | (%) | (Pa) | Factor | (kN/m) | (mgf) |
| 0% CF | 27.6 | 15 | 0.022 | NA* | NA* |
| 2% CF5 | 37.6 | 18 | 0.026 | 0.24 | 370 |
| 5% CF5 | 45.8 | 26 | 0.024 | 0.62 | 873 |
| 5% CF4 | 43.8 | 34 | 0.017 | 0.79 | 995 |

*Not applicable; filter media made exclusively from glass microfibers were too fragile to be tested.

Filter media described above were made from monodisperse glass microfibers. In contrast, commercial media are typically made from blends of fibers of different diameter. For example, laboratory prototypes produced from the recipe given in Table 10 have a MERV rating of 13.

TABLE 10
Filter media composition comprising glass
microfibers of different diameter.

| Mean diameter of glass microfiber | Percentage in blend |
|---|---|
| (μm) | (% wt.) |
| 1.0 | 10 |
| 2.7 | 10 |
| 5.5 | 50 |
| 10.8 | 30 |

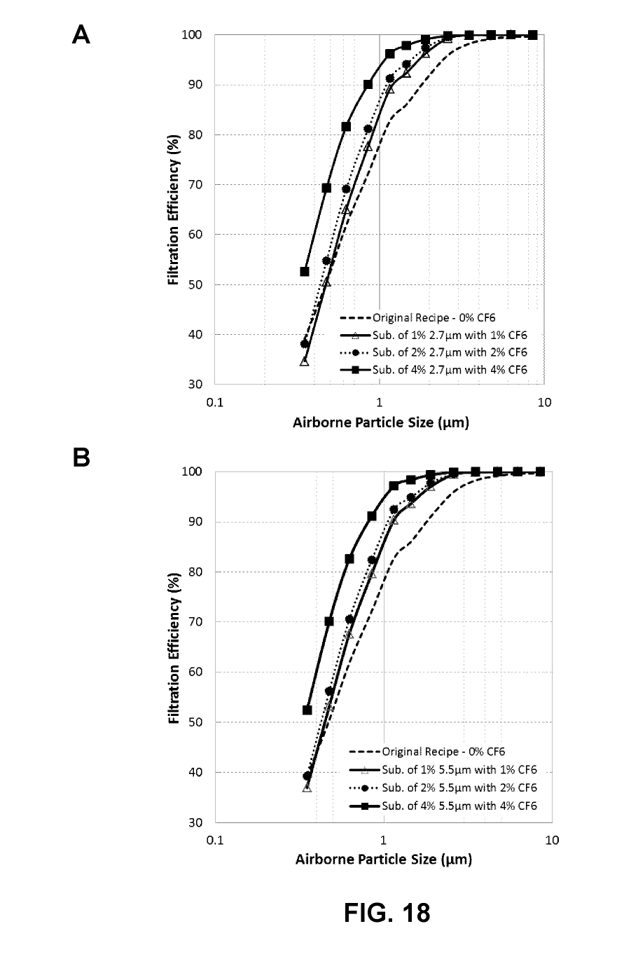

In the examples shown in FIG. 18, varying amounts of CF (CF6) were substituted for glass microfibers of mean diameter 2.7 μm (A) or 5.5 μm (B). In both cases, partial substitution of the glass microfibers with CF led to an overall increase in filtration efficiency. In particular, the filtration efficiency measured at an airborne particle size of 0.35 μm exceeded 50% at the 4% CF addition level. That represents an increase in performance of more than 30%. CF addition also improved the mechanical properties of the media but decreased its permeability (Table 11). Once again, the media prepared without CF were too weak to withstand standard tensile testing.

TABLE 11
Pressure Drop and mechanical properties of prototype media of
grammage 75 g/m² made from blends of glass fibers and CF (CF6)

| | Pressure | Tensile | Gurley |
|---|---|---|---|
| | Drop | Strength | Stiffness |
| Sample ID | (Pa) | (kN/m) | (mgf) |
| Original recipe | 11 | NA* | NA* |
| Substitution 1% 2.7 μm by 1% CF6 | 16 | 0.08 | 90 |
| Substitution 2% 2.7 μm by 2% CF6 | 19 | 0.17 | 160 |
| Substitution 4% 2.7 μm by 4% CF6 | 32 | 0.33 | 283 |
| Substitution 1% 5.5 μm by 1% CF6 | 18 | 0.08 | 73 |
| Substitution 2% 5.5 μm by 2% CF6 | 20 | 0.17 | 136 |
| Substitution 4% 5.5 μm by 4% CF6 | 34 | 0.33 | 251 |

*Not applicable; filter media made exclusively from glass microfibers were too fragile to be tested.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

While a description was made with particular reference to the specific embodiments, it will be understood that numerous modifications thereto will appear to those skilled in the art. Accordingly, the above description and accompanying drawings should be taken as specific examples and not in a limiting sense.

1. A filter medium comprising:
base filter fibers; and
cellulose filaments,
wherein said cellulose filaments are combined with said base filter fibers in proportions suitable for increasing at least one mechanical property of said filter medium as compared to said filter medium without cellulose filaments.

2. (canceled)

3. A filter medium comprising:
base filter fibers; and
cellulose filaments,
wherein said filter medium has a tensile strength of at least about 0.02 kN/m.

4. (canceled)

5. A filter medium comprising:
base filter fibers; and
cellulose filaments,
wherein said base filter fibers and said cellulose filaments form a filtering layer having a thickness of less than 10 mm.

6. A filter medium comprising:
base filter fibers; and
cellulose filaments,
wherein said cellulose filaments are combined with said base filter fibers in proportions suitable for increasing filtration efficiency and at least one mechanical property of said filter medium as compared to said filter medium without cellulose filaments.

7-15. (canceled)

16. The filter medium of claim 3, wherein said filter medium has a bending stiffness of about 1000 to about 10000 mgf.

17. The filter medium of claim 3, wherein said filter medium has a bending stiffness of about 2000 to about 7500 mgf.

18-28. (canceled)

29. The filter medium of claim 1, wherein said filter medium comprises about 0.5% to about 30% of cellulose filaments by weight, based on the total weight of the cellulose filaments and the base filter fibers.

30. The filter medium of claim 3, wherein said filter medium comprises about 2% to about 10% of cellulose filaments by weight, based on the total weight of the cellulose filaments and the base filter fibers.

31. The filter medium of claim 16, wherein said filter medium comprises about 2% to about 5% of cellulose filaments by weight, based on the total weight of the cellulose filaments and the base filter fibers.

32-42. (canceled)

43. The filter medium of claim 1, wherein said filter medium has a tensile strength of about 0.2 kN/m to about 2.0 kN/m.

44-45. (canceled)

46. The filter medium of claim 1, wherein said filter medium comprises about 2% to about 10% of cellulose filaments by weight and wherein said filter medium has a tensile strength of about 0.2 kN/m to about 3.1 kN/m.

47. The filter medium of claim 3, wherein said filter medium comprises about 2% to about 5% of cellulose filaments by weight and wherein said filter medium has a tensile strength of about 0.2 kN/m to about 0.8 kN/m.

48. The filter medium of claim 3, wherein said filter medium comprises about 5% to about 10% of cellulose filaments by weight and wherein said filter medium has a tensile strength of about 0.7 kN/m to about 1.4 kN/m.

49-50. (canceled)

51. The filter medium of claim 1, wherein said filter medium is substantially free of binding material.

52. The filter medium of claim 1, wherein a pressure difference (ΔP) measured at a flow velocity of 10.5 feet/min between a first surface of the filter medium and a second surface of the filter medium is about 1 Pa to about 700 Pa.

53. The filter medium of claim 3, wherein a pressure difference (ΔP) measured at a flow velocity of 10.5 feet/min between a first surface of the filter medium and a second surface of the filter medium is about 1 Pa to about 400 Pa.

54. (canceled)

55. The filter medium of claim 3, wherein a pressure difference (ΔP) measured at a flow velocity of 10.5 feet/min between a first surface of the filter medium and a second surface of the filter medium is about 1 Pa to about 200 Pa.

56. The filter medium of claim 3, wherein said filter medium has a filtration efficiency of at least about 50% for airborne particles having a size of 0.3 μm.

57-63. (canceled)

64. The filter medium of claim 3, wherein said base filter fibers are chosen from glass fibers, cellulose fibers, carbon fibers, ceramic fibers, silica fibers, nylon fibers, rayon fibers, polyolefin fibers, polyester fibers, polyamide fibers, polyaramid fibers, polyimide fibers, and polylactic acid fibers.

65-68. (canceled)

69. The filter medium of claim 29, wherein said base filter fibers are glass fibers having a mean diameter of about 0.5 to about 11 μm.

70-80. (canceled)

81. The filter medium of claim 3, wherein said filter medium has a MERV rating that is increased by at least 1 as compared to a same filter medium without cellulose filaments.

82-84. (canceled)

85. The filter medium of claim 29, wherein said filter medium has a MERV rating of about 8 to about 14.

86-87. (canceled)

88. The filter medium of claim 3, wherein said filter medium is a HEPA filter medium.

89. The filter medium of claim 29, wherein a portion of said cellulose filaments are entangled with said base filter fibers.

90. (canceled)

91. The filter medium of claim 29, wherein a portion of said cellulose filaments coalesce locally, thereby forming a web-like or film-like structure.

92-134. (canceled)

135. The filter medium of claim 1, wherein said filter is used to filter liquids.
